(19) United States
(12) Patent Application Publication
(10) Pub. No.: US 2017/0191262 A1
(43) Pub. Date: Jul. 6, 2017

(54) SELF-TENSIONING MODULAR PANELS

(71) Applicants: Jack R. Forbis, Tulsa, OK (US); Ann R. Forbis, Tulsa, OK (US)

(72) Inventors: Jack R. Forbis, Tulsa, OK (US); Ann R. Forbis, Tulsa, OK (US)

(21) Appl. No.: 15/368,081

(22) Filed: Dec. 2, 2016

Related U.S. Application Data
(63) Continuation-in-part of application No. 14/465,080, filed on Aug. 21, 2014, now Pat. No. 9,512,670.
Application No. 14/465,080 is a division of application No. 13/118,791, filed on May 31, 2011, now Pat. No. 8,851,144.
Application No. 13/118,791 is a continuation of application No. 12/011,595, filed on Jan. 28, 2008, now abandoned.

(51) Int. Cl. E04B 2/74; E04B 1/92; E04C 2/38; E06B 9/24; H02S 20/23; E04F 10/00; E04D 13/00; E04D 13/04; H02S 30/10; E04B 1/80; A47G 5/00

(52) U.S. Cl. CPC E04B 2/7422; E04B 1/80; E04B 1/92; E04C 2/38; E06B 9/24; A47G 5/00; E04F 10/00; E04D 13/00; E04D 13/0404; H02S 30/10; H02S 20/23; E04B 2002/7479

(57) ABSTRACT

An innovative, low-density, highly-insulating modular panel for use in many applications and industries. The panel has a frame that may be preformed or bent and may be made of rigid or flexible material, and a panel covering comprising at least one pocket of thin, low-density shade fabric that has the capability of sufficiently stretching to surround the frame when the pocket is pulled onto it. The pocket may be then secured, along any previously open end where the frame was inserted, by various fastening devices. The panel covering pocket may have additional features added, as described herein. The panel is durable and cost-effective, and has good solar-control and insulating qualities. It is also a windbreak panel, a noise-reduction panel, an impact protection panel, a water-resistant panel, a fall protection panel, and a pollution-control panel. Two or more panels can be joined to create a structure-protecting panel assembly or system.

### RELATED CASES

This application is a continuation-in-part application of co-pending U.S. patent application Ser. No. 14/465,080 filed Aug. 21, 2014, which was a divisional of U.S. patent application Ser. No. 13/118,791 filed May 31, 2011, which was a continuation of U.S. patent application Ser. No. 12/011,595 filed Jan. 28, 2008.

### FIELD OF THE INVENTION

The present invention relates to a unique, modular panel that has significant insulating and protective characteristics along with many uses/applications in various industries. The modular panel of the present invention serves as a new type of “shade panel” (which alone, or in combination with other like or identical panels, creates a new type of “shade structure” or “shading device”). Additionally, the panel of the present invention can be utilized as an improved type of windbreak panel, a privacy panel, and as a greatly improved impact protection panel. The innovative panels of the present invention represent a significant improvement over previously-available technologies or products primarily due to their enhanced performance in regard to heat blocking capacity, hail/impact protection, and wind blocking or deflection capability. This panel may also serve as a new type of sound absorbing/acoustic panel, a water-conserving panel, and in another application, as an improved, more efficient photovoltaic (PV) panel. Thus, the panel of the present invention may be used to produce energy, to save energy, to save water, and to provide many other environmental and/or economic benefits. In several applications, the panels, when in use, help to create environmental credits of various types. The panels of the present invention help protect, and provide comfort for, people, plants, crops, animals, vehicles, buildings, and more. They help create cool roofs, cool walls, cool pavements, and cooler mechanical equipment, as well.

### BACKGROUND OF THE INVENTION

Over the years, various solar-control products have been developed for windows and glazed areas of buildings; for example, awnings and window solar screens. Many types of stand-alone canopies and shade structures have been developed to shade people, vehicles, plants and animals (and in some situations, to also help protect crops from hail damage). Many such free-standing canopies and/or greenhouse structures can be found by searching the internet and in company catalogs such as those from Farm Tek. A roof-shading invention, Forbis et al. U.S. Pat. No. 6,161,362, is also an innovation in providing beneficial shade in a building application. An above-ground storage tank (AST) shade system, disclosed in another Forbis et al. patent, U.S. Pat. No. 7,246,468B2, provides shading/cooling to an AST, thereby helping to prevent product loss due to solar heating of the tank. The traditional method of constructing and installing shade structures such as greenhouse shade-houses (and/or cold frames) and canopies consists of erecting a framework structure (normally of metal) then tightly pulling or stretching “cover” sheets or “tarps” of canvas, non-porous plastic(s) or shade cloth over the top of the framework and securing the cover material to the framework by utilizing bungee-type ties that are made to go through holes (or. “grommets”) that have been fabricated into the covering sheets for that purpose. Alternatively, UV-treated polyrope has been used to fasten the covering to the frame, going through the grommets and around the frame in a lacing pattern. Often, various types of ground anchors or weights such as small sandbags are used to help support the narrow, upright poles of canopies (such as pop-up sports canopies). Some free-standing canopies, such as those commonly found at parks, playgrounds, and automobile dealerships, are known as tensioned fabric structures. Large sections of a thin material are narrowly hemmed around the edges and wire or cable is inserted through the hemmed areas; then when installed, tension is applied to force the structure to take its desired shape. Substantially large support poles or beams are also necessary for these structures. Some shading products for outdoor use are known as “shade sails”, and they are also held in place by cables or ropes.

When constructing shade structures of many types, various challenges arise such as attempting to handle large sheets or sections of shade materials, especially in windy conditions. If shade structures are envisioned and built that do not utilize a “tensioned fabric” strategy, then sagging or drooping of the shade material normally occurs. This may not be a concern in many applications, but in others, it can pose an aesthetic concern or it may result in a product that is not as efficient or as easy to install or handle. The need therefore exists for user-friendly, easily-handled shade or impact-protection panels that do not sag, droop, or exhibit problems associated with existing or previously-invented products/systems. That need also includes the ability to create, provide, and install valuable shading, impact absorbing, or water-saving panels that are of a much more manageable size and that can be easily installed no matter what the environmental conditions, including windy conditions.

That need further encompasses desires within the engineering and architectural communities for new, more highly-efficient products (including improved awnings, sun screens, rainscreens, bird-impact screens, hail-guards, skylight guards, shading devices, and/or solar electric systems) that may be utilized in construction projects (including green building projects), for industrial/manufacturing locations, etc. The need exists for a solar-control (and wind-blocking, impact-blocking or water-saving) product that has a very long service life, has low maintenance requirements, and which may be easily reversed seasonally, or as often as desired, to further increase its service life. The panel of the present invention fulfills those needs.

### SUMMARY OF THE INVENTION

In general, in a first aspect, the invention relates to a system of modular panels for protecting a structure. The system comprises at least one preformed or bent frame and at least one covering into which the frame is receivable. The covering is made from shade fabric and is pocket-shaped, such that the covering has at least one first layer, at least one second layer, a plurality of closed sides adjoining the first layer and the second layer, and at least one open side, such that the covering may be pulled onto the frame via the open side to form a modular panel.

The covering can also be formed entirely, or at least in part, by a stretchy fabric which causes the inventive panels to be self-tensioning.

The system of modular panels may further comprise fasteners located along the open side of the covering such that the open side of the covering may be closed after the covering has been pulled onto the frame. The fasteners may be hook and loop fasteners or c-clips, or edge-protecting structures. The system of modular panels may further comprise an air space formed within the modular panel by the frame when the covering surrounds the frame, and insulation material within the air space.

The frame may be comprised of four corner pieces and four side segments, where the four side segments connect to the four corner pieces to form a rectangular frame. The frame may be comprised of two u-shaped components and two side segments, where the two side segments connect to the two u-shaped components to form a rectangular frame. The frame may be made of flexible material such that the modular panel may conform to a curved structure to be protected by the modular panel. The frame may be foldable or collapsible. The frame can also be an extruded structure. In addition, the frame can be substantially rigid and/or can be formed in a permanent curved shape.

The system of modular panels may further comprise at least one connecting plate assembly, each connecting plate assembly comprising two connecting plates and a plurality of fasteners, such that a connecting plate assembly may be used to join two or more modular panels into a larger unit by sandwiching one corner of each of the two or more modular panels between two connecting plates and joining the connecting plates together with the fasteners. The system of modular panels may further comprise a plurality of panel support cushions. The system of modular panels may further comprise a fastener for mounting the at least one modular panel to an external surface of a structure.

Two or more stacked panels can also be clamped or held together along their edges using the inventive edge-protecting structure.

The covering may further comprise photovoltaic material whereby sunlight striking the modular panel can be converted into electricity.

In another aspect, the invention relates to a system of modular panels for protecting a structure, comprising: at least one preformed or bent frame, where the frame is comprised of two u-shaped components and two side segments, where the two side segments connect to the two u-shaped components to for in a rectangular frame; and at least one covering into which the frame is receivable, where the covering is made from shade fabric, such that the covering has at least one first layer, at least one second layer, a plurality of closed sides adjoining the first layer and the second layer, and at least one open side, such that the covering may be pulled onto the frame via the open side to form a modular panel. The covering further comprises at least one of the following features: the covering is tube-shaped; the covering further comprises photovoltaic material whereby sunlight striking the modular panel can be converted into electricity; the covering is made from shade fabric that is water resistant; the covering is made from shade fabric that is polyethylene combined with shade fabric that is polypropylene; the covering is made from shade fabric used in combination with commercially-available hail-netting; the covering further comprises strips or sections of non-stretchy material attached thereto. The system of modular panels may further comprise at least one of the following features: a water misting system or a drip system, such that water may be delivered to the modular panels, providing enhanced cooling to a structure; an air space formed within the modular panel by the frame when the covering surrounds the frame, and insulation material within the air space; and/or the modular panels are capable of being turned or reversed from time to time to expand the life of the panels.

In another aspect, the invention relates to a method of protecting at least one part of a structure with a system of modular panels, comprising: pulling at least one covering onto at least one preformed or bent frame to form at least one modular panel, where the covering is made from shade fabric and is pocket-shaped, such that the covering has a first layer, a second layer, a plurality of closed sides adjoining the first layer and the second layer, and at least one open side; and protecting a structure with the at least one modular panel. The method of protecting at least one part of a structure may further comprise joining two or more modular panels into a larger unit using at least one connecting plate assembly, where each connecting plate assembly comprises two connecting plates and a plurality of fasteners, where joining two or more modular panels into a larger unit comprises sandwiching one corner of each of the two or more modular panels between two connecting plates and joining the connecting plates together with the fasteners. The method of protecting at least one part of a structure may further comprise protecting the structure from potential harm from the connecting plates by inserting a panel support cushion between each connecting plate assembly and the structure. The method of protecting at least one part of a structure may further comprise attaching the at least one modular panel to an external surface of the structure. The covering may further comprise photovoltaic material, and the method may further comprise converting sunlight striking the at least one modular panel into electricity. Protecting the structure with the at least one modular panel may comprise one or more of the following: reflecting or refracting incoming sunlight; deflecting wind; providing impact protection; providing noise reduction; providing fall protection; providing water-resistance; providing improved pollution-control; providing energy use reduction in summer or winter months; providing infrared heat protection; and creating environmental credits.

In another aspect, there is provided a modular panel for shading, impact and wind shielding, safety protection, and water and energy conservation comprising: (a) a closed-loop frame having a permanent, substantially rigid shape in which at least a portion of the closed-loop frame is curved in an arc of at least 15° and (b) a covering having a first layer, a second layer, a closed peripheral portion where the first layer and the second layer are joined, and an open peripheral portion. The closed-loop frame is fully received in the covering through the open peripheral portion and the open peripheral portion is closed to form the modular panel wherein (i) the closed-loop frame is fully contained in and concealed by the covering, (ii) the first layer of the covering forms a first side of the modular panel, (iii) the second layer of the covering forms an opposing second side of the modular panel, (iv) the first side of the modular panel is spaced apart from the second side of the modular panel, and (v) the covering conforms to the permanent, substantially rigid shape of closed-loop frame so that the first and the second sides of the modular panel, or at least corresponding portions thereof, curve together in an arc of at least 15°.

In another aspect, there is provided a method of reducing evaporation losses from a body of water comprising the steps of: (a) forming one or more modular shading panels, each of which comprising a closed-loop frame and a covering wherein (i) the covering comprises a first layer, a second layer, a closed peripheral portion where the first layer and the second layer are joined, and an open peripheral portion and (ii) the closed-loop frame is fully received in the covering through the open peripheral portion and the open peripheral portion is closed to form the modular shading panel wherein the closed-loop frame is fully contained in and concealed by the covering, the first layer of the covering forms a first side of the modular shading panel, the second layer of the covering forms an opposing second side of the modular shading panel, and the first side of the modular shading panel is spaced apart from the second side of the modular shading panel; and (b) placing the one or more modular shading panels in a floating or a fixed position on or above a surface of the body of water. By way of example, but not by way of limitation, the body of water can be a river, canal, reservoir, fish farm tank or pond, or hatchery.

In another aspect, there is provided a method of protecting and reducing energy losses from rooftops and rooftop equipment comprising the steps of: (a) forming one or more modular panels, each of which comprising a closed-loop frame and a covering wherein (i) the covering comprises a first layer, a second layer, a closed peripheral portion where the first layer and the second layer are joined, and an open peripheral portion and (ii) the closed-loop frame is fully received in the covering through the open peripheral portion and the open peripheral portion is closed to form the modular panel wherein the closed-loop frame is fully contained in and concealed by the covering, the first layer of the covering forms a first side of the modular panel, the second layer of the covering forms an opposing second side of the modular panel, and the first side of the modular panel is spaced apart from the second side of the modular panel; and (b) positioning the one or more modular panels on a rooftop of a residential, commercial, or other building.

In this method, the one or more modular panels can, for example, be positioned (1) substantially end-to-end over a rooftop electrical line, conduit, or raceway; (2) over a skylight; (3) adjacent to and over a rooftop air conditioning unit; and/or (4) at an angle of at least 30° from horizontal over a guttering or other rainwater collection or routing structure to direct falling rainwater into the guttering or other rainwater collection or routing structure.

### BRIEF DESCRIPTION OF THE DRAWINGS

FIG. 1 illustrates a bent frame 4, being viewed from above, having an outer closed frame loop 6 and optional cross-bracing components (represented by the numeral 7).

FIG. 2 illustrates a complete panel 2—one in which the frame 4 has been covered completely by the lightweight fabric/material “tube” or” pocket” 8—and which illustrates optional solar collectors 10 attached to a portion of the panel 2. Hook and loop fastener strips 9 are also illustrated for fastening an open end 24 (of the tube 8, in this example) where the frame 4 had been inserted.

FIG. 3 illustrates an end view of a section of the fabric/material-surrounded frame 4 with an air space 12 in the center.

FIG. 4 illustrates bent and swedged corner components 13 that may be used to construct a frame 4, along with side sections of tubing/framework 30, 32, 34, 36 that fit onto each end of the swedged corners 13.

FIG. 5 illustrates U-shaped end pieces 14 that may be used to construct a frame 4. These U-shaped components receive, and hold in place, the sections of tubing 34, 36 that make up the sides of the frame 4.

FIG. 6 illustrates a universal panel-connecting plate ° that has pre-drilled holes 16, 17 for bolts to pass through to an identical universal panel-connecting plate 15 on the other side of the panels 2. When these two connecting plates 15—one on top of the panels 2 to be held together and one directly underneath—are bolted together (with bolts of the right length passing through small holes, slits or openings in the “tube” or “pocket” panel covering 8), they serve the function of securely holding two or more panels 2 of the present invention together. FIG. 6 illustrates the corners of four panels 2 of the present invention coming together and being held in place by this universal connecting plate 15.

FIG. 7 illustrates a small, lightweight panel support cushion 18. It is sewn in a fashion similar to a small pillow, and it is useful for placing beneath any panel or panels 2 of the present invention that may otherwise rest upon (or touch) another surface. The small cushion 18 serves (in some applications) the purpose of creating a slight space between the panels 2 of the present invention and the object or objects the panels 2 are being used to protect. They are an optional feature, but may be utilized anywhere there is a need to ensure that no damage occurs to an existing surface.

FIG. 8 illustrates an end view of the same panel support cushion 18 as illustrated in FIG. 7. It shows that a seam 19 has been sewn across a previously-open end of the cushion 18 after the cushion 18 has been stuffed or filled with a suitable filling material.

FIG. 9 illustrates an end view of the C-shaped clip 20, commercially available from horticultural supply companies such as Farm Tek, that may be used as an optional means of securing an open end or ends to the frame of the panel of the present invention.

FIG. 10 illustrates another view of the C-shaped clip 20 shown in FIG. 9.

FIG. 11 illustrates another type of finished panel 2 which has several strips of highly-insulating, non-stretchy material 22, 23 sewn, affixed, and/or securely attached to the more stretchy “tube” or “pocket” (panel covering) 8 of the panel 2 of the present invention. This alternate panel covering is then pulled over, and fastened in place, around any suitable frame 4 as shown in FIG. 1, 4, 5 or 13.

FIG. 12 is a perspective view of an embodiment of the inventive modular panel 2 having a curved shape 40.

FIG. 13 is an elevational view of an embodiment of the frame 4 comprising a one-piece, extruded outer closed-loop frame 6 and optional cross-bracing members 7 extending across the closed-loop frame 6 from one side of the outer frame loop 6 to the other.

FIG. 14 is an elevational view of an embodiment of the modular panel 2 having edge protectors 42 attached on two peripheral edges thereof.

FIG. 15 is a front elevational view of the edge protector 42 as seen from perspective 15-15 shown in FIG. 14.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a new, unique, lightweight, modular panel 2 that has excellent insulating characteristics and has many uses/applications. It consists of a sufficiently rigid framework 4 (which is very different from traditional shade structure frameworks and which, in most applications, may be rectangular in shape but also may be square, triangular, hexagonal or any other shape desired for structural or aesthetic reasons) which is covered completely/surrounded by a lightweight, low-density, highly-insulating fabric or material that is adequately flexible or “stretchy” enough so that, when sewn into a tube or into a “pocket” configuration 8, can be pulled onto and over the frame 4. The panel covering tube (or alternatively, pocket) 8 actually becomes self-tensioning due to its ability to slightly stretch and surround a frame 4 of slightly larger dimensions. The flexibility and slight “give” of the preferred panel covering materials allow them to be pulled over any selected/suitable frames. This panel 2 is unique and innovative because panels of this type have never been made before of such material (for instance, shading materials as used in the greenhouse/horticulture industry). With such lightweight, low-density, highly-insulating materials sewn into a tube 8 (having two seams and two open ends 24) or into a pocket shape 8 (having three seams and one open end for framework insertion), many key benefits have been discovered, including the following:

The panel 2 of the present invention becomes a panel that has twice the shade material as any other previously existing shade product. Fabricated and assembled into a modular, easily handled size, the panel covering tube (or pocket) 8 becomes perfectly self-tensioning immediately as soon as it is pulled onto the selected frame 4. This takes away a major problem or concern when trying to apply this type of fabric/material to any type of structure; the fabric/material does not sag or droop if this panel is built properly.

The two layers of fabric/material 8 surrounding the framework create an air space 12 of approx 1½ inches (or more or less, depending upon the dimensions of the selected frame). Air is a very good insulator. More air space on the interior of these panels can be created by increasing the diameter or width of the frame, therefore allowing more separation between the layers of low-density, highly-insulating material (such as horticultural shade cloth/fabrics, woven or knitted of polyethylene or polypropylene threads, for instance) and therefore creating more air space in the panel's center. A “wider” section of air space may increase the panel's insulating capability. Double fabric/material layers with accompanying air space significantly increases resistance of the panel to heat flow. In most cases, and in early testing, most infrared heat simply stops at this panel 2 and does not pass through. The panels 2 of the present invention have been built and tested using varying materials for covering tubes/pockets, and it has been found that the overall panel has good emissivity (ability to release heat). Selecting knitted polyethylene shade fabric, for example, has been a good choice since plastic products are not good “holders” of heat and because this material is thin, lightweight and low-density. Because materials that are less dense are better insulators, such materials will be utilized as panel coverings; coupled with the interior air space, they greatly assist in the construction of a highly-insulating, yet strong and durable, panel for many useful purposes. The panel 2 having such material on both sides of the frame 4, with the frame 4 being completely enclosed in the covering tube or pocket 8, significantly increases resistance of panel (or anything the panel is installed over and protecting) to hail damage. As the top, or uppermost, section or the fabric/material tube is stretched by hail impact, the bottom, or underneath layer may tighten somewhat, especially if panel fabric tube or pocket is a little more loosely attached. Regardless, having double layers of protection far exceeds the amount of protection that one layer alone can provide.

Simplified fabrication/assembly is possible with the panel 2 of the present invention. Most of these new panels can be assembled in five minutes or less, thereby helping keep labor costs at a very reasonable level. The open end or ends 24 or the pocket or tube 8, respectively, can easily be secured with all-weather type hook and loop fastener 9 and/or by C-shaped, slightly flexible clips 20 that are commercially available for holding a layer of fabric of plastic to a section of tubing or pipe. One company offering such C-shaped clipping components is Farm Tek. Each side of panel can be treated individually for either UV or enhanced fire protection. For instance, the side 26 of the finished panel 2 that will received sunlight should have UV-treated material, while an underneath layer 28 (being shaded itself by the panel's uppermost or top layer 26) has no need of UV-treated material and can therefore receive as much fire-protection treatment as possible. It has been a common practice in the commercial “shadecloth” industry to highly treat a shade fabric product for either UV or fire protection, but high levels of protection for both has not been possible. Customers have had to choose which type of protection they primarily want or need for the product they are purchasing. This is why the panel of the present invention is important for building applications. The highly fire-protective treatment being able to be applied to the part of the material which, on our tube or pocket, will be closest to the building is an important innovation and will prove preferable to other types of panels or products.

Panels 2 may be covered with different colors, textures or types of fabric/material (one for each side) or a combination of fabric colors/types may be used together to cover an individual side of the panel. This may be done on one side only, or on both sides of any panel-covering tube or pocket 8. For energy performance, environmental goals or other considerations, panels may consist of a single, universally high-performance material (or color of material) on both sides.

Panels 2 may also incorporate a strong, lightweight aluminized product (for example, one that is commercially available called AlumiNet) on one or both sides of the panel 2 (and either alone or in combination with other lightweight, low-density materials). Prototype panels have been constructed with this material in combination with other panel covering materials for thermal testing and other experimentation. The AlumiNet has also been used by itself on either side of a prototype panel.

Panels 2 may be reversed seasonally, as desired, to enhance the performance of the panel and/or to extend the service life of the overall panel or any of its components. Panels 2 need not be installed exactly parallel to roof, wall or other surfaces, but may be installed at any angle (or in a zig-zag pattern) if desired for longevity, maintenance, performance or other reasons. Logos, messages and/or artwork may be printed onto these new panels and, also, reversed or changed as often as desired. Small, lightweight panel support cushions 18 can be used wherever needed.

More than one fabric/material tube or pocket 8 can be utilized, per panel 2, to increase strength and/or longevity of the fabric/material (or to reinforce a very thin material). For example, one tube or pocket 8 of fabric can be pulled over the frame 4 and secured, and then another tube or pocket 8 of a matching (or different) material can be pulled over the first and fastened in place. Alternatively, different panel covering materials may be selected and sewn or basted together (or in some cases even fastened together with certain adhesives, tapes or hook and loop fastener 9) by placing either “right” sides or “wrong” sides together before being fabricated into tubes or pockets for later panel assembly.

Double or even triple layering of fabrics/materials one over another before sewing into tubes or pockets may be done for one side of the panel only or for both sides. This method of creating panel coverings has already been accomplished in prototype panels, and all without the need to incorporate any “traditional” grommets into the fabrics. UV-treated thread should be used.

Multiple finished panels 2 may be “stacked” together vertically so that there are, effectively, four layers of fabric/material (or more) pulled over two frames 4 with two resulting air spaces 12. This would be especially useful for applications in which much insulation is needed or desired from a panel such as the new panel described herein. Additionally, such “stacked” panels may incorporate a spacer or another means of creating a slight separation between them to give added air space between them (rather than having them rest exactly one upon the other). The panels of the present invention provide new and unique, multipurpose, additional insulation/protection options for use on/around building envelopes as well as for many other valuable uses in industries outside of the building construction industry.

Frameworks/frames 4 may be solid or hollow, and may be formed as one, continuous “bent” frame 6 for strength and uniformity. Framework may be built from various materials such as galvanized steel tubing, aluminum, strong PVC, or fiberglass. Certain types of wood may also be used if desired, especially lumber that is sustainably harvested and certified. For the majority of panels, it is anticipated that a strong, lightweight galvanized steel tubing (as used in chain-link fencing “top rail”) may be chosen because top rail is routinely “bent” into rectangular shapes for creating drive-through or walk-through gates. Fence supply manufacturers have “gate shops” with bending machines, and they can easily manufacture the types of panel frames needed, and frames may be cross-braced. Framework, if not pre-manufactured as a bent, gate-type frame, may be built utilizing unique, individual 90-degree angle corners 13 that are swedged on both ends so that tubing sections 30, 32, 34, 36 of a desired length may be joined to these corners 13, thus forming a mostly-rectangular frame when all sections are put together. These components are useful for being able to build off-sized frames for panels whenever needed (even on location at a jobsite if necessary). One example follows: two ft. lengths of galvanized tubing, bent at a 90-degree angle, may serve as corner pieces 13 and panel size is then determined by the lengths of tubing/pipe selected to go between the respective corner components. Alternatively, frameworks 4 can have end pieces 14 that are U-shaped, one for each end of the rectangular panel frame; and with this option, one only needs to add side tubing sections 34, 36 in any length desired to complete the panel frame 4. These unique U-shaped pieces also are swedged on both ends to receive the side tubing sections. There are some existing connecting components that can be used to join these modular panels one to another, but unique connectors 15 have been developed for this purpose and can be utilized to connect, not only the panels 2 to each other, but also to roofs, walls, support platforms and/or other places that these panels may need to be installed. Special connectors 15 can be used between, along the edges of and/or on the corners of any panel 2. Other key benefits of these modular panels 2, and each of their components, is that they are reusable, easy to handle, and mostly recyclable. When eventually required, the fabric/material tubes or pockets 8 of these panels may be easily and simply repaired or replaced. The panel design allows for any individual panel or panels 2 to be removed, for maintenance or other reasons, without disturbing (or specifically having to remove) adjacent panels if adjacent panels exist. All framework components and connector components can be made of any material strong enough to remain sufficiently rigid under all (or mostly-expected) conditions while still providing the necessary support of the double-sided fabric/material tubes or pockets 8 used to cover the frames 4. In some applications, a totally rigid framework will not be a necessity; meaning that some amount of flexibility of the overall panel (including the framework itself) may be preferable depending upon where and to what the panel 2 is to be applied. The panels 2, individually or as a grouping, can also be made waterproof for certain applications by pulling a waterproof material such as a sheet or sheets of heavy-duty, opaque plastic over the top side of the panel, if desired. These panels, then, could be used as quick, reliable, easily-built temporary/emergency shelter or housing—or even as longer term housing if needed. Tops of these panels 2 could also have a waterproof coating product added in such applications. Waterproofing plastic sheets and/or coatings may be applied only to the underneath side of the panel, if desired, so that the top or uppermost side of the panel of the present invention would serve to shield the lower, coated or plastic-covered layer from direct sunlight and any accompanying weathering and deterioration that the sun's heat would normally cause to such plastic sheet(s) or coating. The panels 2 of the present invention, due to their strength and insulating characteristics, can be used to provide beneficial free-standing structures themselves—giving shelter from excessive heat, cold and wind (and from hail) even if they are not made waterproof. The panels of the present invention can provide blockage of heat transfer, hail strikes and blockage/deflection of wind currents anywhere desired in many industries, including but not limited to the following: Building construction, agricultural, industrial/manufacturing (including on-shore and off-shore oil and gas production and storage), civil engineering projects and for use in renewable energy systems such as solar electric/photovoltaic systems. The panel 2 of the present invention can serve as a brand new type of base material for the attachment of solar collectors 10, and it will prove to be more efficient than many other types of materials onto which solar cells/collectors have previously been mounted or affixed. If a solar panel can stay much cooler while in bright sunlight, it is more effective at producing power from that sunlight. The solar collectors 10 can be mounted on one side, or on both sides 26 28, of the panel 2 of the present invention. If mounted or affixed to both sides, this new, unique solar panel can then be installed in an operable position so that one side of the panel can “face” the easterly sun to generate power during the morning hours of the day; then, as the sun passes over head and “moves” to the west, the solar collectors on the other side of the panel 2 of the present invention will receive full sunlight and they will generate power during the afternoon hours. A panel 2 of this type, which has not existed before, may avoid the need for mounting brackets that must move throughout the day in order to “track” the sun's movement and keep the solar panel properly positioned and “facing” into the direct sunlight. In addition, the panel 2 of the present invention may be misted with small droplets of water, on one or both sides of the panel, especially if misting could enhance the solar output of such a novel panel 2 by helping keep it much cooler than other solar panels. The panel of the present invention may also have flexible, thin, lightweight solar-collecting tubes 10 imbedded, or woven, into it; that way, the solar collectors 10 would not be mounted or affixed to the modular panel 2, but would rather be an integral part of the panel and/or its covering material(s) from the very beginning. The panel 2 of the present invention may also be useful as a sound-absorbing panel or a new type of acoustic panel to be installed in or around facilities of many kinds. According to the article “Acoustics: Absorb, Block, and Cover,” by Jana J. Madsen of Building Magazine (found on the internet at www.buildings.com/Articles/detailBuldings.asp?ArticleiD=3182 and accessed on Jul. 25, 2006) materials that are lightweight and porous are good choices for trying to control noise levels in facilities. The panels 2 of the present invention may thus serve to absorb, help block or deflect unwanted noises in/around a home, a school building or workplace. The panels 2 of the present invention can also be useful as a means of screening flying embers or sparks from getting to a rooftop in an area prone to wildfires.

The following applications for the panel of the present invention's use in various industries are examples of the most likely uses, but should not be considered all-inclusive.

### Building Construction:

This panel 2 may be used as an improved interior or exterior insulating panel (for example, over roofs, rooftop equipment, walls, parking spaces, walkways, pool/spa covers, patio/deck covers, carports adjacent of homes/businesses, motor home or boat shelters, etc., or inside attic spaces, wall cavities, ceilings, around ductwork, garages, workshop spaces, barns and/or sheds). The panel 2 of the present invention can also be used as a new alternative to traditional tents, canopies, and/or other types of shelters; and it can be added to most existing types of tents or canopies to make them even more effective and/or durable. The panel 2 of the present invention may be used to help reduce noise levels in/around buildings, as mentioned above. The panel 2 of the present invention may be used as a protective panel for skylights. Various amounts of natural light can pass through the panel of the present invention depending upon the exact type of lightweight, low-density material that is selected for the panel's “tube” or “pocket” (its covering). The panels of the present invention provide twice the shade, wind, and hail protection for skylights than any previously-existing technology or option. This new panel 2 may be used in conjunction with “green roofs” or rooftop gardens. Rooftop gardens are most prevalent in mild climates and are left open to the sky; however in hot climates, this may cause the planted vegetation to endure too much heat and water consumption. The panels herein described, again, provide twice the amount of shade, wind and hail protection than any previously-existing technology or option. By filtering sunlight and its associated heat, these panels can help the soil or other planting media retain moisture longer, thus conserving water. The panels 2 of the present invention can be used as an uppermost, protective covering for existing, traditional roofing materials (including paints or coatings that may crack, peel, blister or warp under the stress of direct solar insolation) and/or rubber roofs, tar-and-gravel roofs, metal roofing that contains fasteners that become worn-out over time due to heat from the sun causing expansion and contraction of the metal sheets). The panels 2 of the present invention may also serve to protect shingles and certain types of tile roofing products, as well. Roof-life extension can be provided by the panels 2 of the present invention by significantly helping to stabilize the temperature of the traditional roofing materials; in fact, they may serve to double to triple the normally-expected service life of such products. According to the (U.S.) White Coatings Council's report on roof durability, a “rule of thumb” for thermal aging of roof materials is that for every eighteen degrees of temperature rise (above ambient) on rooftops, the roofing system's life is cut in half. The unique panels 2 describe herein easily and cost-effectively help significantly reduce thermal aging due to temperature rise. The report, “White Coatings Council: Lowering Temperatures Greatly Enhances Roof Longevity,” was accessed on the internet at www.buildings.com/articles/detail.asp?ArticleiD=3206 on Jul. 24, 2006. Temperatures on many traditional roofing materials, under bright, sunny conditions, have been measured at seventy to one-hundred degrees F. above the ambient air temperature. The panels 2 of the present invention can lower surface temperature on these materials to ambient, and/or slightly below ambient. Each panel 2 of the present invention creates an instantly-cool environment for traditional roofing products as soon as it is in place. It is important to note that the panels 2 of the present invention are not expressly intended to replace any such traditional roofing product, but rather to protect them along with providing valuable benefits to the building owner such as energy-savings and improved comfort level for occupants. Water passes through the panels 2 of the present invention; therefore a need still exists for traditional roofing products to serve as a water-tight membrane for the buildings. With the panels 2 of the present invention in place, rainwater is shed from the rooftop just the way it would if these new panels were not there. The panels 2 of the present invention do not create a problem due to water “ponding;” and in most instances, they have been, and will be, installed very close to the traditional, existing roof surface. Adequate access to any equipment is maintained, and walkpaths (narrow pathways leading form the edge of roof out to equipment installed on the roof, such as HVAC equipment) are provided where necessary; however actually walking on/across the panels of the present invention is normally not a problem. The panels of the present invention may also provide protection to wall systems/facades wherever desired. They may help protect siding from hail impacts, and they may serve as improved, two-sided awnings, overhangs, louvers or any other exterior shading device. This will keep windows and/or other “glazed” areas considerable cooler than currently available awnings, overhangs, louvers or solarscreen window panels. The panels 2 of the present invention provide twice the shading capacity as any currently-available option. Many applications within the field of architecture are possible for these new panels 2, and they represent unique, multi-purpose protection options for many types of building envelopes. The panels 2 of the present invention may be designed (or retrofitted) to any building to help hold heated or cooled air inside a building if/when power outages occur. Design for Survivability is what architects are calling the effort to make buildings more inhabitable if, for example, a natural disaster has occurred and people are having to “shelter-in-place.” Often, electricity supplies are disrupted. Buildings may not have backup generators available; but even if backup generators are available, if the panels 2 of the present invention are installed on/around the building, then the building is better equipped to withstand extreme heat or cold from the outside (thus making it more protective for occupants of the building and definitely more survivable). The panels 2 of the present invention also serve as an improved method or strategy to further conserve energy and reduce electricity bills. Installation of the panels 2 of the present invention allows building owners to slightly raise the thermostat setting in summer/warm months and/or to slightly lower thermostat settings in cold weather months of the year, thereby helping save energy and money that would be spent on electricity or other fuels. This raising or lowering of the thermostat settings is possible due to the blocking or deflecting of wind currents at selected areas on or around the facility. The panels 2 of the present invention additionally serve as a method or strategy to help create “green,” environmentally-friendly buildings that may receive “high-performance,” “LEED” (Leadership in Energy and Environmental Design rating from the U.S. Green Building Council) and/or “Energy Star Building” designations. (Energy Star is a partnership program started by the US EPA and US DOE to help improve building energy performance, and it involves product manufacturers, also). The panels 2 of the present invention, if/when water mist is applied, provide superior levels of cooling to the surface or surfaces they are protecting and do this with a much lower level of water use than any previously-used, described or invented shading system. Water droplets, when applied to the “underneath” side 28 of the panel 2 of the present invention (that side of the panel 2 not in direct sunlight and shielded by an “upper” 26 side of the panel which is in full sunlight), remain on the panel considerably longer (normally three to four times longer) than the amount of time water droplets are able to remain on an upper layer or side of the panel under hot weather conditions. For example, if an upper panel (or a single-layer shade panel alone) is misted for ten seconds, on a hot afternoon that panel 2 may need to be re-misted at ten or fifteen minute intervals; but if the underneath layer of panel covering material 8 is misted for the same length of time (ten seconds) the time between misting cycles can be stretched out to thirty to thirty-five minutes or even longer, depending upon how hot and/or windy it is at that location on that particular day. Thus, the panel 2 of the present invention dramatically saves water over anything described in prior art. Finally, the panel described herein serves as a method or strategy to create carbon-reduction and/or other environmental credits or offsets. Saving energy use in buildings can lessen the amount of carbon dioxide released to the atmosphere by power plants. This is increasingly important as climate change reduction solutions are being discussed and are receiving more attention as the years go by. In widespread application, the panels 2 of the present invention (along with other energy-saving and renewable energy devices, systems and products) can provide a significant role in helping to clean the air, to protect human health, to help lower the number of power plants that must be built, and to help slow down the rate of climate change/global warning.

### Agricultural Applications:

The panels 2 of the present invention can be used as new, improved panels for construction of greenhouses in the horticulture industry, and may be used as an added insulating panel anywhere on (but especially on the outside of) existing or traditional greenhouses. They may also be useful as improved housing and/or shelters for livestock such as cattle, or for populations of wildlife; and they may serve as wind-blocking panels for protecting plants, crops, animals or people from extreme cold/winter winds and as an improved impact-resistant panel to help protect all of the above from damage or injury in the event of extreme hailstorms. The panels 2 of the present invention may also be used as permanent or temporary shade shelters for agricultural workers. A panel 2 (or several panels 2 connected together) could have wheels or skids attached to the bottom edges of them so that they would be made portable/moveable, towable or even self-propelled (so that they are capable of being easily relocated to other areas/sections of an agricultural field, for instance, as work progresses across the field). Alternatively, the panels 2 of the present invention can be attached to (or mounted on) existing trailers thereby creating very cool, portable “cooling stations” for farm workers to take short breaks from the sun's heat. The panels 2 of the present invention can also be used as a completely new means of protecting water supplies in agricultural, and other/applications. The panels 2 described herein can be useful for water holding/storage areas (including water tanks), for water treatment facilities, and especially for irrigation/aqueduct channels. Much water is lost to evaporation throughout the hot summer months of the year, and the panels disclosed herein are exceptionally capable of helping slow and greatly reduce such evaporative water loss. The panels 2 described herein are also useful within the agricultural community as a means/method of helping protect grain storage areas and/or wine/grape production/storage areas. These panels 2 can help maintain a desired temperature range for these (and other) stored agricultural goods and products. Also, they can serve to provide valuable, extra insulation for meat processing facilities, dairies, refrigerated warehouses, etc. Another valuable use is for wood/lumber preservation. These panels help maintain proper humidity levels for optimum wood product storage, thereby helping prevent premature drying, cracking, or splitting of the cut lumber as often happens when wood/lumber is exposed to direct sunlight and too much heat. The hotter the environment around the lumber, the lower the humidity level and the more likely lumber is to crack or split or warp. The panels 2 described herein can help reduce ambient temperature in and around wood product storage areas (at the same time increasing humidity levels) which is very beneficial for the shelf-life of lumber.

Another use for the panels 2 of the present invention is in the area of erosion-control. Anywhere on a farm or ranch (or in areas where highway construction or expansion is taking place) where there is a need to control soil erosion, the panels described herein can be utilized. “Silt Fence” products are routinely used in these areas, and they consist of a single layer of heavy-duty “Geotextile” material, usually black, attached to one side only of wooden ground stakes. The lower portion of each stake, being pointed, is pounded into the ground and spaced wide enough so that the geotextile material is stretched between them and supported, with the bottom of the geotextile material being at ground level. The panels 2 of the present invention (due to the fact that they are double-sided, can be formed using two or more layers on one or both sides, and due to the fact that water will pass through the panels' covering materials 8 in most cases) provide a superior “silt fence” product. Additionally, when used as a silt fence solution, the lower portion of the panel of the present invention should be installed slightly below-grade rather than simply resting upon the ground. This will improve the erosion-control capacity considerably. Panels for this application can be made in any height and length suitable for the job; but an exemplary dimension may be two feet high by ten feet long. In this example, the panel's lower 6 to 12 inches should be installed below ground level; and the soil replaced will serve to hold the panel(s) in place, possibly avoiding the need to have additional ground stakes. Stakes of wood, or other suitable materials, can still be used to reinforce these new silt fence panels; and the panels are easy to handle and ship/transport to a jobsite or to any area needed on a farm or ranch.

Another way the panels 2 of the present invention can be especially useful in an agricultural setting is for protecting colonies of bees. Beehives can have the panels 2 of the present invention attached to them, on any or all sides, and/or be installed in such a way that they provide temperature-control to several beehives at once. Panel “tubes” or “pockets” 8 can be selected that are sufficiently “open” enough in their weave so that the bees are able to pass through to the hive; or, alternatively, small holes, slits or any other type of opening can be made into the panels of the present invention to allow the bees to reach the hive(s). One side of each panel could consist of traditional, commercially available “hail netting” which has quite a bit of room between the strands of the netting; then the other side of the panel could be made of commercially available shade fabric (with gaps, holes or slits fabricated into it to allow bees easy access to the hive). There is presently great concern about declining bee populations here (and possibly in other areas of the world, too); thus the panels 2 of the present invention will help protect and conserve bee populations by providing much needed shade and temperature control (and wind-blockage or wind-deflection as well wherever needed in areas that bees inhabit).

Further use in faun and ranch applications lies in the panel 2 of the present invention serving to help protect and conserve fuel supplies. These unique panels provide an entirely new means of shielding fuel tanks from excessive heat gain (in summer months) and to help stop fuel evaporative losses no matter what season. The panels 2 of the present invention provide twice the shading and wind-protection to fuel supplies than any previously-existing or described technology or product. Currently-existing (and recommended) fuel tank storage shelters (being constructed of materials that are much denser, opaque, or both) are not as effective at protecting fuel tanks and their contents from unwanted heat gain. Used in cold weather months, also, the panels 2 of the present invention can help block cold northerly winds, help prevent frost and ice formation on the tanks, etc., that the fuel storage tanks would otherwise endure if left exposed to the elements. This can play a role in helping maintain the structural integrity of the tank or storage vessel/container.

These new panels 2 are especially effective where single-walled, above-ground fuel storage tanks are concerned, and they help to significantly reduce or to “narrow” the diurnal “swing” in fuel temperature, thereby helping save valuable product and reduce “standing loss” (or breathing loss) emissions to the atmosphere from uncontrolled or unprotected storage tanks/vessels. Prototype panels of the panel of the present invention have been constructed and put in place around single-walled barrels holding unleaded gasoline (both painted bright white and oriented the same direction on the same property; one left open to the elements and one protected by the panels of the present invention—a parallel-type of test/demonstration), and there have been significant gasoline surface temperature differences observed and recorded between the unprotected fuel container (open to the sky) and the barrel surrounded and protected by the panels of the present invention. Saving fuel helps the economic situation of farmers/ranchers while at the same time helping protect and extend our fuel supplies on a state and national level, thereby helping to contribute to our energy security.

### Industrial Applications:

The panels 2 described herein have various uses in industrial/manufacturing settings. They may be used to help improve industrial organic and/or inorganic product storage. They may be used in summer or winter as desired to provide added insulation and protection to many, many types of storage vessels. Single-walled, fixed-roof storage tanks are projected to significantly benefit from use of the panels of the present invention since heat from the sun can cause considerable losses to occur, particularly if such single-walled tanks are holding a high vapor pressure substance. By helping reduce or even eliminate the amount of solar insolation and heat that is able to even reach the storage tank, valuable product can be saved and the local environment can be improved. Because the panels 2 of the present invention are highly-insulating and lightweight (yet very strong, durable and easy to handle and install), they serve as a great improvement over any other type of shading strategy or invention for storage tanks (especially above-ground storage tanks and/or mobile storage tanks of various types) such as the type of pollution-control, product saving shade structure described and disclosed in Forbis et al U.S. Pat. No. 7,246,468 B2. The panels 2 of the present invention do not have the drawbacks of trying to attach any type of cables and/or heat-insulating blocks to a storage tank, having to deal with the time-consuming process of attaching a multitude of shade fabric “clips” around cables and onto strips or sections of shade material, etc. The panel 2 of the present invention can have an interior framework 4 that is a little more flexible, if needed or desired, so that, for instance, the finished panel 2 may be slightly bent or curved to match the curvature of a storage tank. As many of these slightly flexible, modular panels 2 as needed may then be joined together and installed around the circumference of the storage tank/vessel and/or over its top. The panels 2 may come into contact with the walls or roof of a storage tank or may be completely stood off from the exterior of the tank(s). This capability greatly enhances the usefulness of the present invention in regard to protecting storage tanks, whether they are stationary or mobile. Additionally, the panels 2 of the present invention may be used on/around floating roof aboveground storage tanks to block wind currents, thereby helping to stop (or greatly reduce) wind-related losses of product. Panels of the present invention, again due to their lightweight, yet strong, nature—along with the number of variations in the dimensions of the finished, ready-to-install panel(s)—can be constructed to attach to and surround the upper portions only of such floating roof tanks (for instance, around the top, “rim” area only) so that crosswind currents are effectively blocked at that level only. Alternatively, the wind-blocking panels of the present invention may be taller and sized to cover the entire side (or sides) of the tank and to extend above and beyond the top of the tank for wind/blocking and deflecting purposes. The panels 2 may extend straight upwards or be bent or positioned at any angle desired to achieve effective blockage of wind currents. Another industrial use for the panels 2 of the present invention is to use them to add another level or layer of insulation to heated storage tanks. These tanks also, depending upon their location and the climatic conditions they experience, may benefit from the wind-blocking capabilities of the panels of the present invention. In addition to heated storage tanks/vessels, refrigerated storage tanks and containers at industrial locations may also benefit from use of the panels 2 of the present invention. In fact, some substances being stored at low temperatures may become very unstable, and possibly explosive, if subjected to suddenly-rising temperatures. Such a situation may occur if a power outage takes place at the plant or in case certain equipment were to fail. The panels 2 of the present invention, if installed in an operable position around these types of storage tanks/vessels to help prevent solar heat gain, could help provide valuable minutes for plant operators to restore electrical power, to install back-up generators or to take other measures to get the situation under control. This application for the panels 2 of the present invention definitely serves as a safety measure for helping protect life and property simply by shielding such tanks from exposure to unwanted or undesired heat from the sun especially if, as detailed above, there happened to be an unexpected power failure at the plant.

Further industrial/manufacturing uses follow, but should not be considered to be all-inclusive: These innovative panels 2 may be used as corrosion-reduction panels anywhere desired in/around an industrial plant. This is because the panels 2 of the present invention effectively shield objects from the normal forces in the environment that cause degradation of materials (i.e. too much heat, the sun's direct UV rays, heavy “driving” rainfall, ice and sleet, hailstones, blowing sand, dust, dirt or any other debris that would normally impact the objects being protected/shielded if the panels 2 of the present invention were not in place to protect them and reduce the likelihood of damage to those objects). These new panels 2 will be especially helpful in the protection of pipelines; again as an inhibitor to corrosive forces, either natural or other hazards such as certain potentially-corrosive chemicals that could blow or drift onto such pipelines if left uncovered/unprotected. The panels can be made long and narrow, for instance, to more readily conform to normal pipeline configurations, and can be joined together to cover the entire pipeline (or any particular expanse desired) either inside or outside of an industrial plant's boundaries.

Additionally, the panels 2 of the present invention could be used to help protect, and shield from unwanted solar heat gain, industrial equipment “enclosures” or “equipment houses”. These are most often air conditioned, and use of the panels of the present invention around them could allow smaller air conditioning units to be installed/used and still accomplish the desired/needed level of cooling. The panels 2 described herein can be installed to protect the walls only of such enclosures (especially a west-facing wall that absorbs great amounts of heat from the sun during warm weather conditions) and they can be used to shield the top of the enclosure only or completely surround the enclosure, effectively putting the enclosure “in the dark”. This should significantly help maintain the desired temperature range for the enclosed equipment. In some locations or climate zones, the use of air conditioning equipment may then be optional.

The panels 2 of the present invention may also be able to add extra protection/insulation for boilers and/or combustion units wherever effective, desired and feasible. The panels 2 described herein can help block heat loss from such units, and adequate access by workers can always be designed and allowed for if utilized for this, and other, purposes. Additionally, the panels 2 of the present invention can be used to enhance the effectiveness of chiller units, ice-making equipment and/or cooling towers by keeping excess heat from reaching the units and (in the case of cooling towers in industrial settings) by keeping cooling tower water from blowing/drifting out of the tower. The inner layer of fabric/material of the panel 2 of the present invention becomes another surface on which heat exchange/transfer may take place, while the outer layer/side of the panel continues to screen out harmful heat from the sun, to keep windblown debris from entering the tower, to keep birds and/or other wildlife from entering the tower, etc. This can definitely help maintain the cooling tower at its optimum working condition, help reduce maintenance and repair costs, etc. This innovative double-sided, protective shade panel of the present invention (with desirable air space between the two sides) will perform much better for enhancing cooling tower performance than any existing or previously-described method, strategy or technology.

The panels 2 of the present invention can very cost-effectively create a much “cooler” cooling tower (and/or chiller or compressor units) thereby increasing its efficiency and effectiveness as part of the heat exchange process. The cooler the overall tower or chiller or ice-making equipment can become, the better it can be at performing its intended function. The panels 2 described herein can also be used to cover “make up” water areas, serving to keep the water itself considerably cooler during hot weather conditions than it would be otherwise. Shielding make-up water areas from direct solar insolation can help conserve water as detailed above in the agricultural applications section of this specification; and the panels 2 of the present invention may be attached or affixed to any type of floatation device or structure as needed to enable them to be positioned properly slightly above or over the water supply. Alternatively, the panels 2 (when/if used in such an application) can be constructed in long enough dimensions to effectively reach across the water to the other side, and can even be attached to any type of truss or beam that would allow the water supply to be sufficiently “spanned”. Still referring to use of the panels 2 of the present invention in cooling tower applications, they can also help lower the make-up water temperature so effectively that much more heat could be removed from the hot, incoming water, and that it could happen much more quickly. This cooling tower efficiency improvement can help the overall operation of the plant by speeding up the cooling process to a certain degree. This can serve as an economic advantage (for the users of this unique, modular panel 2 of the present invention) over competitors in industry that do not incorporate this solution into their operations. Additionally, the panels 2 of the present invention can be useful in blocking external heat from the sun that would normally reach distillation towers in refineries. Much cooler distillation towers could greatly assist in timely product separation/formation. This, too, would be a significant economic advantage to users of the panels 2 of the present invention for this purpose. The panels 2 described herein may also be used along industrial “fencelines” (or boundaries) as a windbreak and/or as a chemical drift-control barrier system. Alternatively, they may be used in these areas simply as a physical and/or visual barrier or screen. Panels 2 can be built to any desired height, utilizing any desired framework 4 that is sufficiently strong enough to hold up to industrial expectations/standards, and they may be supported by various means and materials. These new, innovative panels 2 can also be useful as windbreak panels and/or as temperature moderation/control panels for onshore and offshore drilling operations/areas. This panel 2 can be a worker protection and safety product by blocking (or helping to block) extreme winds and, thus, can help in preventing workers from being blown off rigs or platforms. The panels 2 of the present invention can also be useful for creating more moderate working temperatures and conditions for employees, thereby assisting efforts to improve their health and safety. The panels 2 of the present invention can also be used to surround (either completely or partially) oil storage tank “batteries”, pumper units and compressor units at these locations. Tank “batteries” have not been shaded/protected from the sun's light and heat before, and they will be able to retain more of their stored product if the panels 2 of the present invention can be installed in an operative position around them. They need not be installed around each tank within such a tank battery, but rather (since they are often in close proximity one to another) several tanks within the “battery” could be covered and protected by a single, larger modular panel of the present invention. In some cases, all of the tanks at such a “battery” can be shaded and protected by a single shade structure that is made up of one or more of the panels of the present invention. Additionally, at any type of oil-drilling location where housing is provided for workers and/or where temporary offices are put in place (such as trailers, mobile homes and/or modular buildings), the panels 2 described herein can help keep them much more comfortable whether they have air-conditioning/heating systems, evaporative cooling units, fans (or any other means of providing comfort and temperature control) or whether they do not have this equipment.

Providing benefits relating to fall-protection can be another function/use of the panels 2 of the present invention in many areas, including industrial areas. They may be attached or affixed firmly and securely to any existing beam or scaffold where fall-protection is desired, thus serving as a new type of safety barrier system. This will be very useful for companies with workers who must carry out their duties at locations high above ground-level (either at industrial plants OR for workers in construction such as high-rise office building contractors, window washers, rooftop workers/repairmen who must get onto roofs no matter what the height, etc.). The panels 2 of the present invention can be attached very securely to high walkways, scaffolding, roof parapet walls and other existing places where workers go in order to add an extra measure of protection against accidental falls. Even though regulations require measures such as ropes, cables and worker harnesses to be worn, the panels 2 of the present invention can serve as a back-up strategy in case the other, normally-used equipment were to break or fail. Such innovative, modular, fall-protection panels are strong, lightweight and easy to install and to take down as needed. They can be easily re-used and moved to other locations. It is possible that company insurance rates might be able to be lowered somewhat for firms that would employ this additional method of worker safety-barrier. Actually, the panels 2 of the present invention can be used anywhere in or around an industrial plant to keep it cooler for workers and/or equipment, to help protect against accidental falls, to help protect workers in certain high-risk areas from being hit and possibly injured by any debris that might come loose from a nearby area of the plant and suddenly come flying their direction (the panels 2 described herein thus serving simply as an impact barrier), and/or as noise-reduction panels, windbreak panels, water-screening panels and/or dust-control panels.

As described in the agricultural applications section of this specification, water will (or may) pass through the panels 2 of the present invention, thus they may be useful as an alternative means of “screening” out unwanted debris or particles from a water stream. Additionally, the panels 2 of the present invention may be useful within industrial and/or manufacturing areas by aiding in dust control. This would be especially true if these new panels were installed anywhere that drifting of dust is a concern. The panels 2 of the present invention can serve as easy to build and install (and very easy to maintain) dust-collection panels, particularly if they are moistened with droplets of water or any other type of substance that could be sprayed, misted or applied to the surface or surfaces of these new panels 2. If utilized as such a new type of dust control “screen” (or filtering or collection device), the panels 2 of the present invention may be cleaned periodically by simply spraying with a water hose (with little or no shaking or scraping needed). Again, because these new panels 2 (in an exemplary embodiment) are double-sided, with valuable air space in the center of each panel, they are capable of “screening” more particulate matter that all or most other available options. (For example, whatever particles may make it through the first, or outer, side of the panel 2 could be “caught” by the material on the other side of the panel, especially when the panel covering tube—or pocket 8—is designed and fabricated to have a material on that side that is more tightly knitted or woven than the material that makes up the other side of the panel.) In this application, the panels 2 of the present invention can assist a community or region with efforts to reduce particulate matter (PM) particles in the atmosphere; therefore additional environmental credits and/or incentives may be able to be obtained.

A further use for the panels 2 of the present invention (which encompasses not only the areas of industrial/manufacturing but the agricultural industry, as well) is for use at/around ethanol production and storage facilities. The panels 2 of the present invention will help to significantly protect ethanol supplies and/or fuel mixtures that contain ethanol (such as E-85) from evaporative losses due to heating by the sun (and/or from wind-related losses of product). Buildings (especially those not having much existing insulation), sheds and other types of shelters in these areas may also benefit from use of the panels of the present invention.

### Civil Engineering Applications:

The panels 2 of the present invention can be used on or near bridges or overpasses where traffic moves to help block or deflect high winds that can cause drivers to lose control of their vehicles. High profile vehicles are often blown over when navigating across bridges and overpasses by strong winds, and the panels of the present invention may be used as very effective wind-blocking panels 2 to help protect drivers from encountering such dangerous winds. These innovative, durable, modular panels 2 may be attached to any type of beam or support structure as may be required; and in the case of attaching to bridges, these panels can make use of the beams that are already a part of the bridge, thus adding additional support beams to hold our panels (which would add more weight to the bridge) would not be necessary in most cases. New bridges and overpasses can be designed and engineered with the panels 2 of the present invention in mind (from the very beginning of the project) to allow for any type of support attachment device or systems that would be needed or required.

The panels 2 described herein can be used near aircraft runways (especially for those used by general aviation and small aircraft and/or helicopters) to help block crosswinds that can cause trouble for pilots when taking off or landing. The panels of the present invention can be made however tall and however wide they need to be to accomplish this (and, again, they can have support mechanisms that are sufficiently engineered to securely hold them in place under all, or most, environmental conditions).

The panels 2 of the present invention can also help protect bridge support columns, wherever feasible, from impacts by small watercraft and/or barges. In the past, barges have crashed into bridge supports and have caused considerable damage under stormy and/or windy conditions.

If the panels 2 of the present invention were in place to help shield and protect the bridge support columns (and due to the slight “give” and stretchability of the panel coverings of this new panel), those support columns could be shielded and protected by one or more of the panels of the present invention. The panels would themselves receive most of the force from the impact, and even if some damage were to occur to such protected bridge support columns, the damage would be less than if the panels described herein were not present serving as a barrier around them. The panels 2 of the present invention can be spaced at any reasonable distance away from the bridge support column(s) as needed. Additionally, if the panels 2 of the present invention were in place to help protect bridge support columns or posts from accidental impact, another benefit would occur. The panels 2 of the present invention, when installed securely and permanently, would help protect such bridge support structures from strong wave action and the erosion or deterioration that can cause damage to said bridge support structures. These new panels 2, in an operative position, can help slow down (and deflect, to a certain extent) the force of strong waves, thereby helping preserve the service life of bridge and/or overpass support columns over rivers, lakes, canals and other waterways.

Another use for the panels 2 of the present invention is in constructing outdoor pavilions, gazebos, auto-racing facilities, sports stadiums/complexes, etc. The panels 2 of the present invention would be especially helpful if put in place around sports stadium “sky boxes” and/or enclosed areas designed for media reporters/announcers. These are normally located very high in the stadium, to provide excellent views of all that is taking place on the field below, and they receive lots of direct sunshine as well as strong wind currents (as wind speeds increase with height). The panels 2 of the present invention can serve to help shield and protect sky boxes and other enclosed areas of a sports complex thus making them much more comfortable for occupants.

Additionally, the panels 2 of the present invention can be useful as a new type of highway sign and/or outdoor billboard. These double-sided panels can provide a lightweight, strong, non-glare producing surface on which to print motorist warnings/messages and/or advertising. Because the “tube” or “pocket” 8 panel covering materials can be porous in nature, not as much wind load would have to be allowed for, thereby allowing for less heavy support poles or beams on which to install them (which saves natural resources).

The panels 2 of the present invention can be used in areas that are experiencing loss of ice and/or the melting of permafrost. These innovative panels provide excellent insulating capacity, so their usefulness in these applications could be important. Single sheets of non-porous/non-permeable white plastic have been stretched over the end of a glacier before (in Switzerland, per a report found on the internet) to try to stop its melting; but the panels 2 described herein (when constructed of many different colors) have many advantages over using a single layer (or even more layers) of that white non-porous plastic (which is likely to be whipped about by the wind and damaged, and which does not have nearly the insulating capabilities of the presently-described modular panels).

A similar project was undertaken in Greenland, also (using large sheets of white plastic held down by large wooden beams) in an attempt to try to slow down the loss of ice. Wood heats up in direct sunlight, so it is possible that the heat from the large wooden beams used would still transfer to the ice that the white plastic sheeting is trying to protect and save. Again, the panels of the present invention would be a more effective ice-preservation alternative.

At the other extreme of climatic conditions, the panels 2 of the present invention may be useful to help create much more moderate temperatures for humans and/or for wildlife in desert areas. Use of the panels of the present invention, in any configuration desired, can also help to lessen the likelihood of dust storm initiation. Severe dust storms and sand storms are often begun due to the extreme heating of the desert caused by intense, relentless sunlight; and then these sand and dust storms have devastating impacts on nearby populated areas. Along with being a health hazard to humans, they cause a great deal of damage to property. The panels 2 of the present invention may be able to assist in the reduction of some of these sand/dust storms (or at least to provide dust and/or sand “screening” panels to block large amounts of sand and/or dust from reaching certain cities, villages, wildlife habitats/zoos, to protect equipment that must remain outdoors, etc.).

An additional use for the panels 2 of the present invention is attaching them to handrails that are part of lift platforms and certain types of industrial ladders and/or to carts and industrial “wagons” used to move supplies. Having the panels of the present invention installed to “close in” presently open sides of these handrails and platforms can further increase their effectiveness and safety. For instance, items or tools (if accidently dropped by the person or persons handling them when atop such ladders or lifts) could fall through the open spaces between the metal railings, thereby possibly striking people working at ground level nearby. The panels 2 of the present invention, even if installed on only one side of a ladder or platform where this could occur, can stop the item or tools from falling off the platform. Regarding their application for various types of carts and wagons, the addition of the panels 2 described herein can also help keep items being moved exactly where they belong. (This would be also helpful in regard to hold luggage carts known as Bellman carts, even if the panels 2 of the present invention were only installed on the more narrow open ends of these carts, leaving the larger open ends to remain open as they are now.) Any type of utility cart, “stock” and/or “order-picking” cart (as used in warehouses) and/or any type of wheeled cart, wagon or trailer used at the site of a large outdoor construction project may benefit from the use of the panels 2 of the present invention. Many types of fork-lifts have one section of metal screening to help protect a person on its platform from coming in contact with the mast; and the panels 2 of the present invention could be used as an alternative, lighter-weight option for such a screen. Many types of commercially-available carts, lifts and wagons and scaffolding may be found at www.globalindustrial.com and by searching for other industrial supply companies.

The catalog for Global Industrial can be obtained by contacting the company at 2505 Mill Center Parkway, Suite 100, Dept. DL2, Buford, Ga. 30518-3700. The panels 2 of the present invention can, thus, be used for additional fall-protection, not only around scaffolding at construction and/or civil engineering projects, but also for creating improved carts, wagons and lifts that will help keep people and/or tools from falling off them. They can be brightly-colored to catch the eye.

### Renewable Energy Systems:

The panels 2 of the present invention may be used in the area of renewable energy, as mentioned earlier in this specification. New solutions for providing energy (and/or for helping existing renewable energy systems perform more efficiently) are needed; and the panels 2 of the present invention can help. They may be used as wind-deflection or concentrating panels to help improve performance and output of wind farms (primarily onshore, but possibly offshore as well). The panels 2 of the present invention can be strategically placed, and securely supported, wherever needed in the vicinity of wind farms to help increase wind speeds approaching the wind turbines that are generating electricity. This may help more power to be generated, even on not-so-windy days, than the amount of power that is currently able to be produced. The presently-described, innovative panels may be made as high and/or as wide as needed (and made from any color so as not to detract from the natural surroundings such as green—to blend in with grass-covered low hills or meadows—or even blue to blend in with the clear, summer sky). They may be placed so that they help gather, and increase the speed of, the wind to selected wind-generating equipment within a wind farm only (not all).

Additionally, the panels 2 of the present invention can be used as a new “base” material for solar panels. Existing types of solar collectors 10 may be attached or affixed to the panels 2 of the present invention (as described earlier in this specification). Thin, flexible solar-collecting tubes 10 may also be incorporated into the panel 2 of the present invention. Solar cells and collectors 10 of many types may be able to be applied to the panel 2 of the present invention, and the completed panels may be free-standing. They may also be attached to new or existing buildings to generate energy for use within the building while at the same time helping to protect the building's envelope from hail, extreme winds and harsh sunlight. BIPV—Building-Integrated PhotoVoltaics—is an important field of endeavor in which solar cells/collectors and/or panels are designed into (and incorporated with) a building from the very beginning of the project. The panels 2 of the present invention are especially suited to be utilized within this field of BIPV. As noted earlier, finished solar panels 2 of the present invention may have solar collectors 10 on one, or both, sides 26, 28; and they may be installed on rooftops so that sunlight is received by one side of the panel virtually all hours of the day. They may be installed in a flat or horizontal way (for instance, slightly above and parallel to a flat-roof surface); and they may be also installed along walls of buildings, walkways and parking areas (as well as being used as a new type of solar electric overhang, awning, solar screen, entryway, “canopy”, shading device for glass “sunrooms” in hot months, etc.). They can also be used to shade and cool balconies (such as those on high-rise hotels and/or multifamily/apartment buildings) while, at the same time, providing some electricity to be used within the building itself.

Extra electricity produced can often be supplied back to the utility company's grid so they may send it to other customers, especially at times of peak demand (which most often corresponds with the hottest, or coldest, times of the day and months of the year). Additionally, the panels 2 of the present invention can be used, alone or in combination with mechanical cooling equipment, at truck stops, highway rest steps, truck loading areas, etc., in order to provide an environment conducive to allowing truck drivers to turn off their engines, thus avoiding “idling” emissions. The panels 2 described herein, even without PV/solar collectors incorporated, can provide enough of a comfortable environment for trucks to park under (allowing them to avoid running the air conditioning unit of their trucks) in many moderate climate zones; but in very hot, sunny climate zones, the panels of the present invention with the solar collector components added can be very helpful in that they not only help provide a cool, shady place for truckers to park when they need to take meal breaks and rest breaks, but these new panels can provide some, or all, of the electricity needed to run cooling equipment (while greatly lowering intake air temperature and increasing its efficiency)! Smaller air conditioning units may be able to be specified to provide the desired level of cooling with the panels 2 of the present invention in place. Another possible use for the panels of the present invention is within space programs. Photovoltaic systems are used on the international space station; and these new panels may be able to be installed there at some point in the future and/or be used to shade/cool and provide power from the sun for communications satellites that orbit the earth. The panels of the present invention, since they are lightweight and highly-insulating (and especially if they can be made in such a way as to be even more easily transported and assembled) could serve as solar electric/solar control solutions. They could even be used as windbreak panels to help protect equipment and/or people who may some day inhabit Mars (which has severe windstorms).

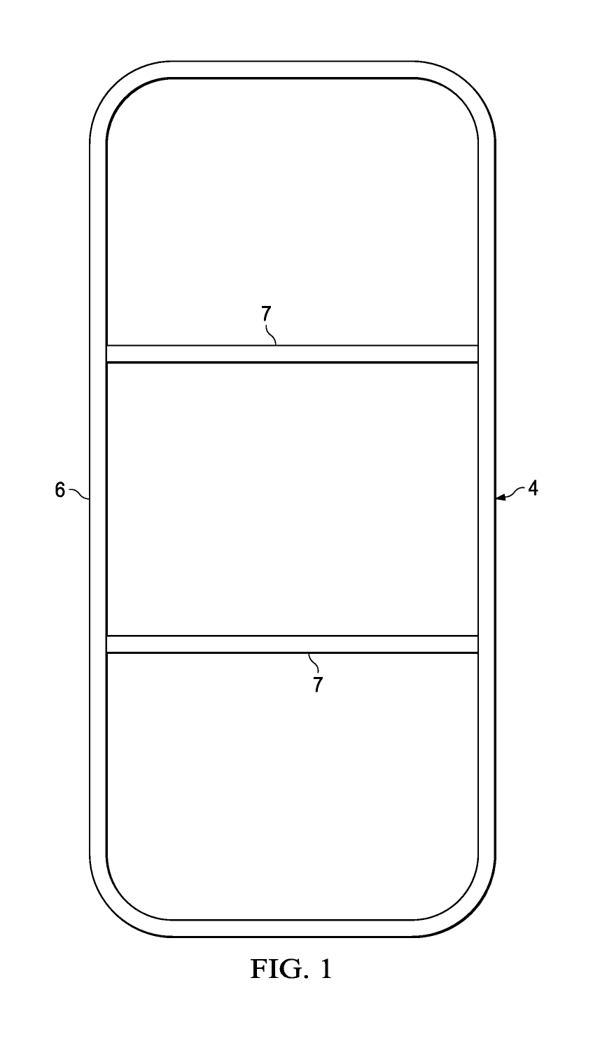

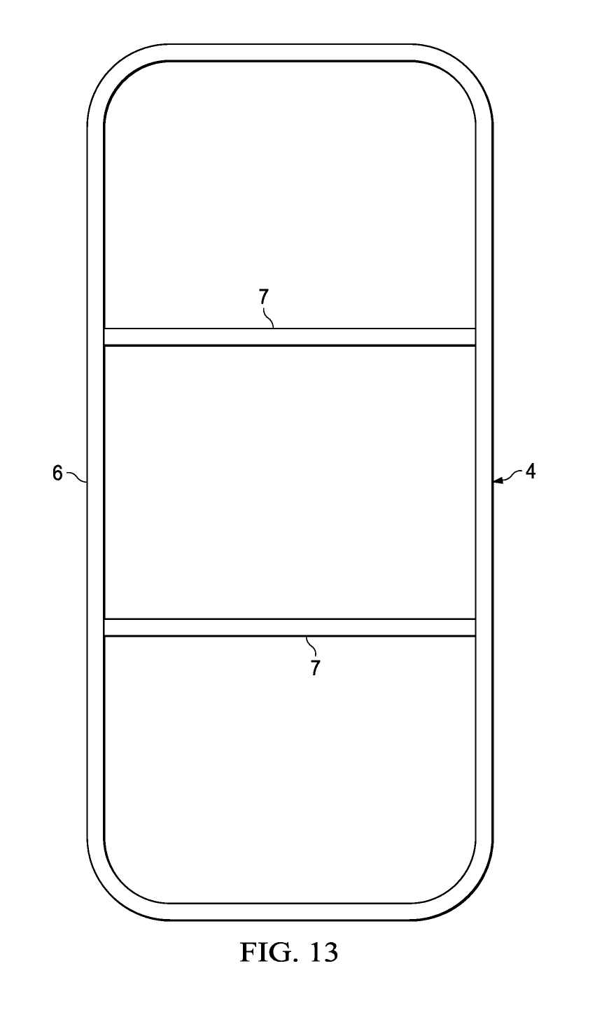

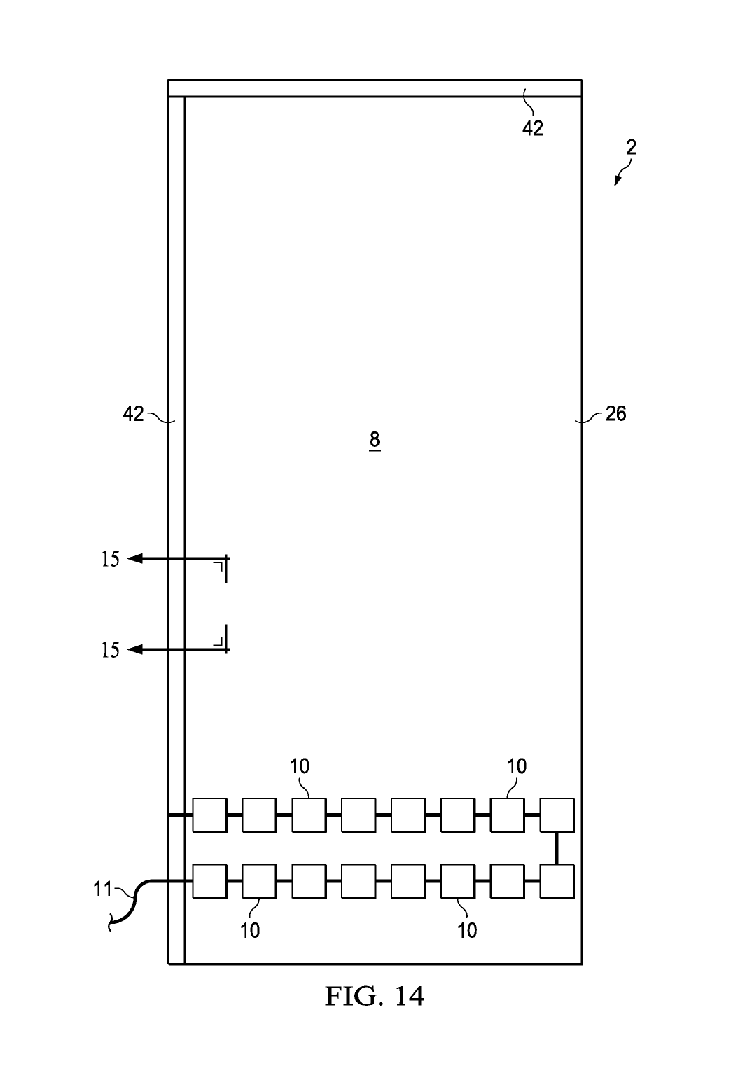

Exemplary embodiments, though not the only embodiments, of the present invention and their advantages are best understood by reference to FIGS. 1 through 15, where like numbers are used to indicate like and corresponding features.

Referring to FIG. 1, a frame 4 is constructed of any suitable material. This frame 4 is the first step in constructing the panel 2 of the present invention, and it may be cross-braced for extra support or not. By way of example, but not by way of limitation, this drawing shows a bent frame, the type of which is commonly made for construction of metal gates. Other materials, rigid or somewhat flexible, may be used to construct this frame. The outer or main section of the frame 4 is a closed-loop frame represented by the number 6, and the optional cross-bracing is represented by the number 7. Materials chosen for the frame 4 may include galvanized steel, aluminum, PVC, fiberglass, wood or and other suitable material. The frame 4 may be rounded or curved, alternatively it may be in the shape of “square tubing”, rectangular or any other desired shape. Preferably, it should have a smooth surface so that the “tube” or “pocket” 8 covering of the panel 2 of the present invention may be easily pulled over it if made of galvanized steel, the frame 4 may be powder-coated if desired or needed, especially if the completed panels 2 are going to be installed in coastal areas. Frame materials may be chosen based upon locally-available materials, climatic conditions and/or other considerations especially the needs and preferences of the customer or user of these new panels 2. As discussed earlier in the specification, a frame 4 that is a little more flexible may be desirable if, for example, it is needed to enable the finished panel 2 to bend slightly to conform to, or to “follow” the curvature of the object or structure it is being installed to help protect. This may be for structural, or simply for aesthetic, reasons. Another feature of any frame 4 for the panel 2 of the present invention is that it may be made to be a folding of collapsible frame so that ease of shipping/transport may be enhanced and/or for use in certain types of applications where such a frame preferred. The frame 4, if made to be collapsible, or one that is capable of folding, ideally will be easily “locked” into the proper, full-length position before the panel covering “tube” or “pocket” 8 is pulled over it. Additionally, since the panels 2 of the present invention have many applications, are very durable and reusable, ideally any such collapsible or folding frame will be easily returned to the collapsed or folded position when necessary if the user of these new panels 2 desires them to be moved to another area of the facility and reinstalled or for any other reason. The frame 4 could be made to collapse or fold after removing the panel covering(s) 8 only; but it should also be very easily-designed to be folded (in one or more locations or points around the frame's perimeter) so that this can be accomplished with the panel covering(s) 8 still in place since all, or at least most, panel covering “tubes” or “pockets” 8 will continue to be made from stretchy materials. A folding and/or collapsible frame 4 is only an optimal feature of the panel of the present invention (not shown in FIG. 1); however, it may become a preferred framework in some applications.

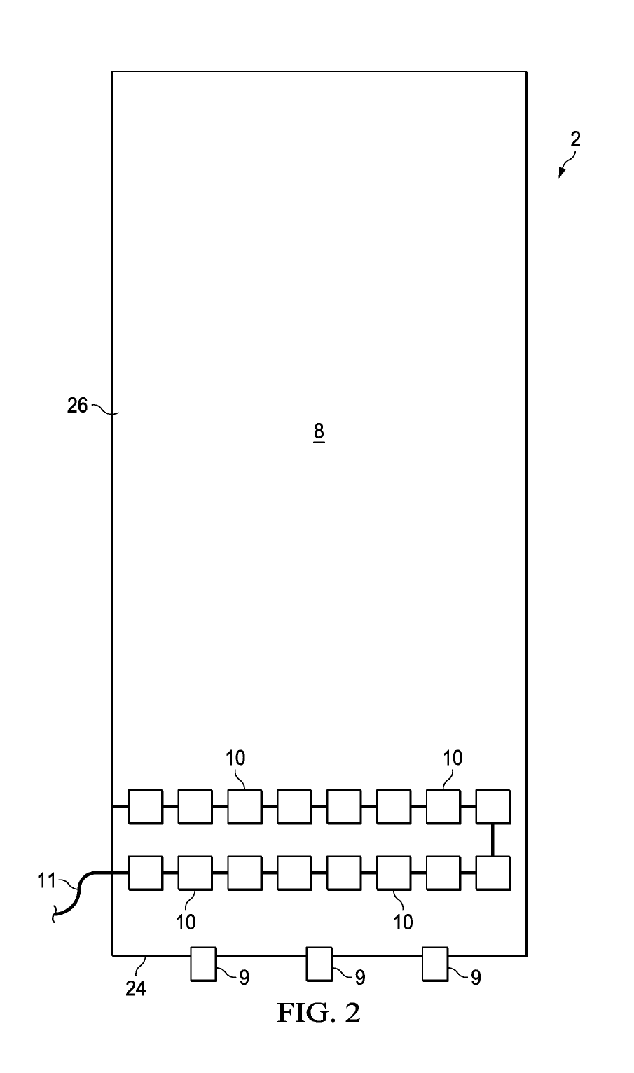

Referring to FIG. 2, an embodiment of a complete panel 2 is shown which has the lightweight, low-density and highly-insulating material pocket (represented by the number 8) pulled over the frame 4, and perfectly self-tensioned. The frame 4 is now hidden by the pocket 8 that has been pulled onto and over it. Many colors and types of materials are suitable to create the pocket 8 shown, including knitted polyethylene “shade fabric” such as that available from Dewitt Company, Pak Unlimited, Farm Tek and others. Additionally, polypropylene shade fabrics, polyester shade fabrics, AlumiNet, and/or other lightweight, low-density materials capable of being sewn may be selected. The number 9 represents hook and loop fastener fasteners for the open end 24 of the pocket 8 to be closed and secured, following the insertion of the frame 4. Only one side of each hook and loop fastener 9 is shown. The other corresponding hook and loop fastener piece would be on the other side of the panel, near the open edge 24 and placed in a position so that when open edges of the panel covering are brought together and slightly overlapped, the hook and loop fastener pieces 9 may be pressed together, thus securing the panel covering 8 around the frame 4. Hook and loop fastener 9 for outdoor use is available from Home Depot and many other companies. Number 10 represents solar collectors which have been affixed to a portion the panel's pocket/covering 8. These solar collectors 10 are optional and may be utilized to produce electricity from the sun's light under suitable weather conditions. Several types of solar collectors 10 are commercially-available and are suitable for incorporation into the panel of the present invention. All solar components selected will have been UL (Underwriter's Laboratory) approved. Number 11 represents the wiring that carries the DC electricity generated by the solar collectors 10 to an inverter (not shown) for conversion to AC power.

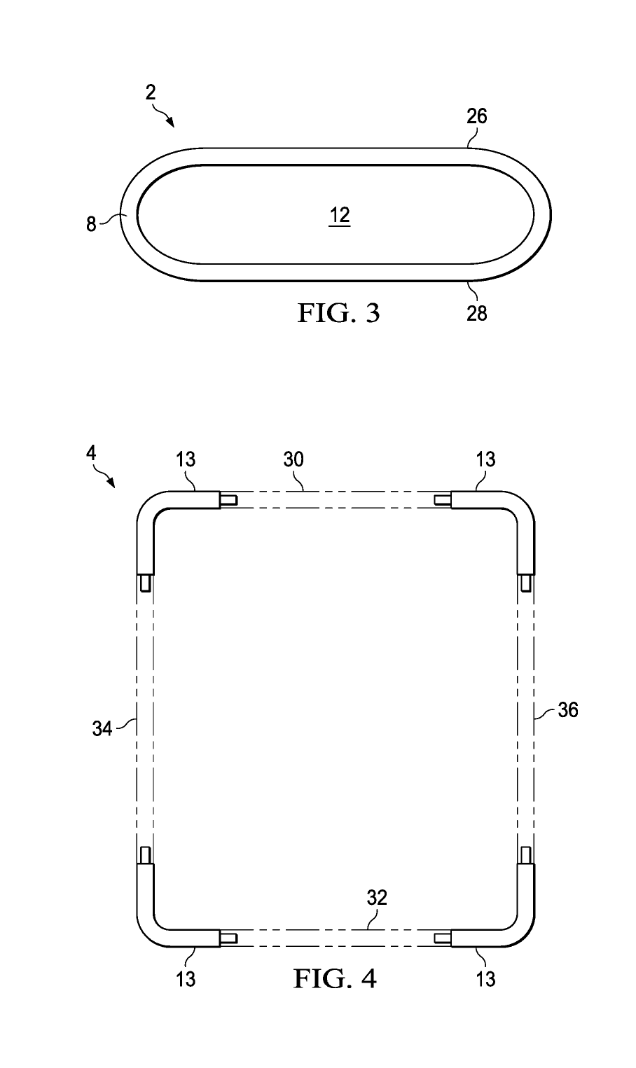

Referring to FIG. 3, Number 12 depicts the open air space that is created between the upper layer 26 of panel covering material 8 and the lower or underneath layer 28 of panel covering material 8 when the panel 2 is fully assembled. It shows that “upper” and “lower” panel covering materials 26 and 28 are uniformly spaced from one another and do not touch, sag or droop. This uniform, even air space 12 is possible because the panel covering 8 of the panel 2 of the present invention perfectly “self-tensions” when it is pulled into place around the frame 4. The air space 12 remains when open ends or edges 24 of the panel's “tube” or “pocket” covering 8 are brought together, slightly overlapped and secured. This air space 12 should not be considered “dead air space” since the panels 2 of the present invention will, in most instances, utilize low-density, highly-insulating materials that are porous. The air within the air space 12 is not completely “trapped” or sealed inside the panel 2 but, rather, it is actually able to move or pass slowly through the panel covering 8. This characteristic of the panel 2 of the present invention allows it to have good insulating capabilities. However, the interior air space 12 could alternatively be replaced, if desired, with another lightweight insulating material suitable either for indoor or outdoor use. This could be a very lightweight foam product, strips or bits of recycled paper/cardboard, recycled plastic bags or strips, recycled strips of commercial shade fabric (such as scrap material that the manufacturers who make such shade fabric, or who fabricate products from it, must have hauled away), polyester fiberfill, Aerogel, or a plastic/air bubble product such as that normally called “bubble-wrap” (or any other suitable material with good insulating qualities). Naturally, any insulating materials that would deteriorate after getting wet would not be selected to be a part of the panels 2 of the present invention designed for outdoor use. Filling up the air space 12 of the panel 2 of the present invention is not necessary at all in order for the panel 2 to serve many, many valuable functions; however in some applications, utilizing one or more panel-filling substances in the interior portion 12 of each panel 2 could enhance the performance of the panel 2 described herein even further. As described above, the Number 12 in this drawing shows where the air space exists; and this would be the same location for any alternative insulating material that may, in certain instances, take its place in the center of the panel 2 of the present invention.

Referring to FIG. 4, Number 13 represents an example of a corner component that may be used to construct the panel 2 of the present invention. Four such corner pieces 13 are needed per panel, along with top 30, bottom 32 and side segments 34 and 36 of pipe or tubing (shown by dotted lines) that will complete the square or rectangular framework 4. This corner component 13 may be made of any material that is strong enough to serve the purpose of holding the other (top, bottom and side) segments 30, 32, 34, 36. These corner components 13 have been made especially at the request of the inventors of the panel 2 of the present invention and the prototype swedged corner components 13 were made of galvanized steel tubing. PVC is also a good frame/corner component material since curved sections of the PVC exist for other uses and can be (and have been) adapted by the inventors of the panel 2 of the present invention for the purpose of constructing other prototype sample frames 4. As described in the paragraph regarding FIG. 1, any other suitable material may be used for these corner components 13, including aluminum, fiberglass, wood, etc.

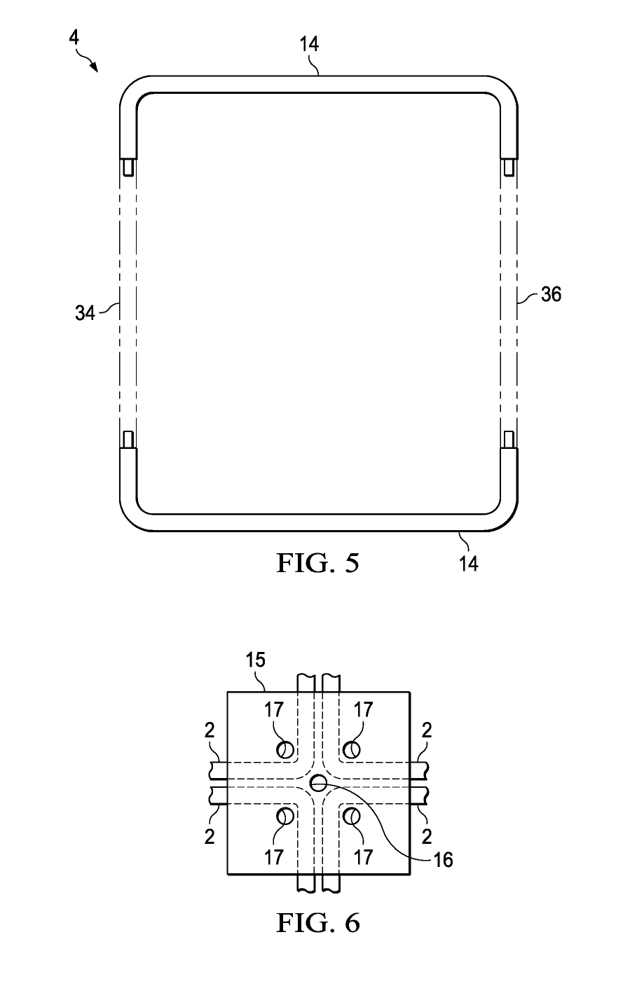

Referring to FIG. 5, Number 14 represents an elongated, U-shaped “end” component which may be used to construct the frame 4 of the present invention. Two of these U-shaped end components 14 are needed, along with “side” pieces or segments 34 and 36 (shown by dotted lines) that the U-shaped end pieces 14 will receive and attach to. This drawing shows an alternative means of constructing the frame 4 of the present invention than the one represented in either FIG. 1 or 4. End pieces 14 may also be constructed or fabricated from any suitable material, although the most likely materials would be (as described regarding corner components 13, detailed above) galvanized steel tubing or PVC, depending upon the application, location to be installed; but as discussed above regarding FIGS. 1 and 4, any other suitable material may be used for the U-shaped end components 14 including aluminum, fiberglass, wood, etc.

Referring to FIG. 6, Number 15 represents a universal panel-connecting plate that, when used in pairs, can serve the purpose of joining and securely holding in place two or more of the panels 2 of the present invention. In this drawing, universal panel-connecting plate 15 is made in a square shape, but a rectangular shaped connecting plate 15 could also be used, especially if desired in order for the plates to reach across slightly more of the surface area of the finished panels 2 they are meant to hold together. This plate 15 may be made of metal such as ¼″ or ½″ thick galvanized steel.

It may also be constructed of aluminum or of any other suitable material that would be sturdy enough to accomplish the task of holding panels of the present invention together at their corners. Holes 17 are pre-drilled in the positions shown (or in other positions on the connecting plate that may be required from time to time) so that bolts (or any type of suitable pin, rod, or other similar type of fastener) can be inserted through each hole 17, pass through small openings directly below them that have been made into the panel covering material 8, and then to pass through identically-spaced and pre-drilled holes on the universal panel-connecting plate 15 on the opposite side of the panel 2 of the present invention. Bolts should be selected so they are not too long, but rather so that they will be the right size to extend slightly beyond the second, or lower, plate 15 and so that a nut of the proper size can be threaded onto the bolt's end and securely tightened. The Number 16 represents the center pre-drilled bole, and the Number 17 represents one of four other pre-drilled holes positioned outward from the center hole 16 (each being in an operative position to hold the corners of each finished panel 2 without having the bolt scrape against or damage the corner sections of any frame 4. The dotted lines in FIG. 6 represent the frame corners (covered with panel covering material 8 and ready to be connected one to another) of four finished panels 2 of the present invention.

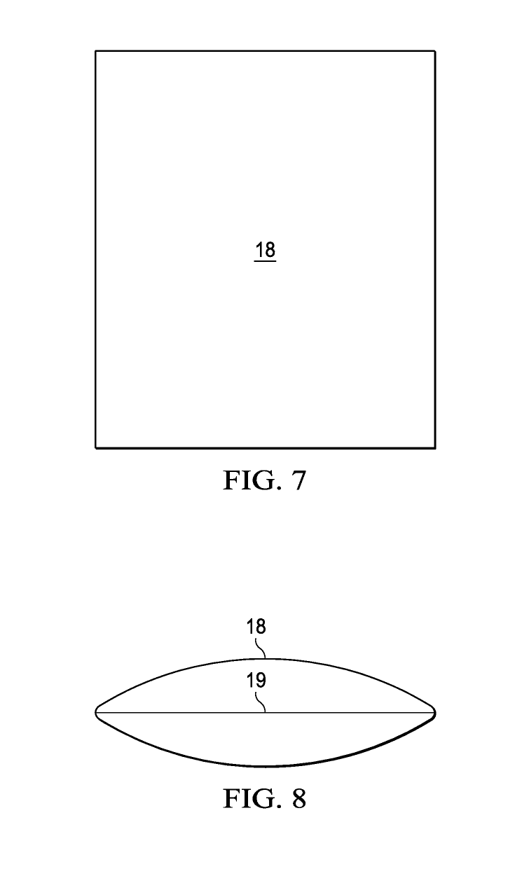

Referring to FIG. 7, Number 18 represents the top side of a panel support cushion, made in a manner similar to the way in which a “knife-edge” toss pillow would be made. It may be made from any suitable material that is capable of being sewn; however an exemplary choice is to use the same type of panel covering material selected to make up the panel 2 of the present invention's “tube” or “pocket” 8. This may be a lightweight, low-density material such as commercially available shade fabric; and it may be made of polyethylene, polypropylene, polyester, and/or any type of knitted, woven or non-woven material desired. It may be filled with any suitable material; but prototype panel cushions already in use have been made of white polyethylene shade fabric with filling consisting of recycled plastic grocery bags. This makes a very durable and suitable cushion to place where panels 2 come together and are joined by the universal panel-connecting plates 15. Panel cushion 18 may be used in any application when: a little space is desired between the panels 2 of the present invention and the surfaces or objects they are being installed to protect.

They may also be used, even if extra space is not needed or desired, just to be sure that the panels 2 of the present invention do not do damage to any other object or surface. There are no hard parts or surfaces in panel cushion 18.

Referring to FIG. 8, the Number 19 represents the seam that was sewn to make panel cushion 18 closed and finished following the insertion of filling material. This view of cushion 18 is an end view. Cushion 18 can be made thicker or thinner depending upon how much or how little filling material is put inside it.

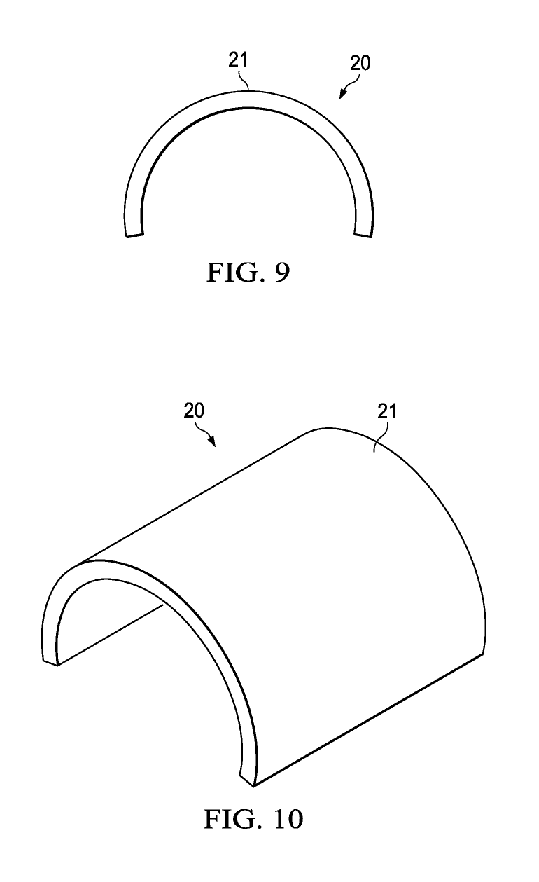

Referring to FIGS. 9 and 10, Number 21 represents one curved edge of a C-clip 20, as seen in an end view, which may be used as an alternate means of securing the open end of the “pocket” panel covering 8 of the panel 2 of the present invention This C-clip 20 may also secure both ends of a “tube” panel covering 8 of the new panel 2 described herein if a “tube” is fabricated to cover the panel's frame 4 rather than a “pocket”. C-clips 20 such as this are available from Farm Tek. They are normally approximately three inches in length, and one of them can be placed every twelve inches (or as needed) as panel covering open edges are brought together and slightly overlapped. A tool is not needed to utilize the C-clips 20. Pressure is applied to the C-clip 20 with a slight rocking motion of the hand, when panel covering material is ready to be fastened. The C-clip 20 is forced into place to hold the panel covering 8 onto the panel 2 of the present invention. Although these C-clips 20 are not presently offered in longer lengths than three inches, the inventors of the panel of the present invention have found out that the manufacturer of this clip 20 would make them available in longer lengths (for instance 12″, 24″, 48″ or even as long as needed) so that fewer clips 20 would be needed for each panel. A longer C-clip 20 would most likely save time during assembly of the panels 2 of the present invention.

Referring to FIG. 10, again, the number 21 represents one curved edge, or end, of the C-clip 20 that may be used to fasten panel covering material 8 to frame 4 of the panel 2 of the present invention. This view of the C-clip 20 is from a different angle so that a side and the top of the C-clip 20 may be seen. The number 20 represents the C-clip.

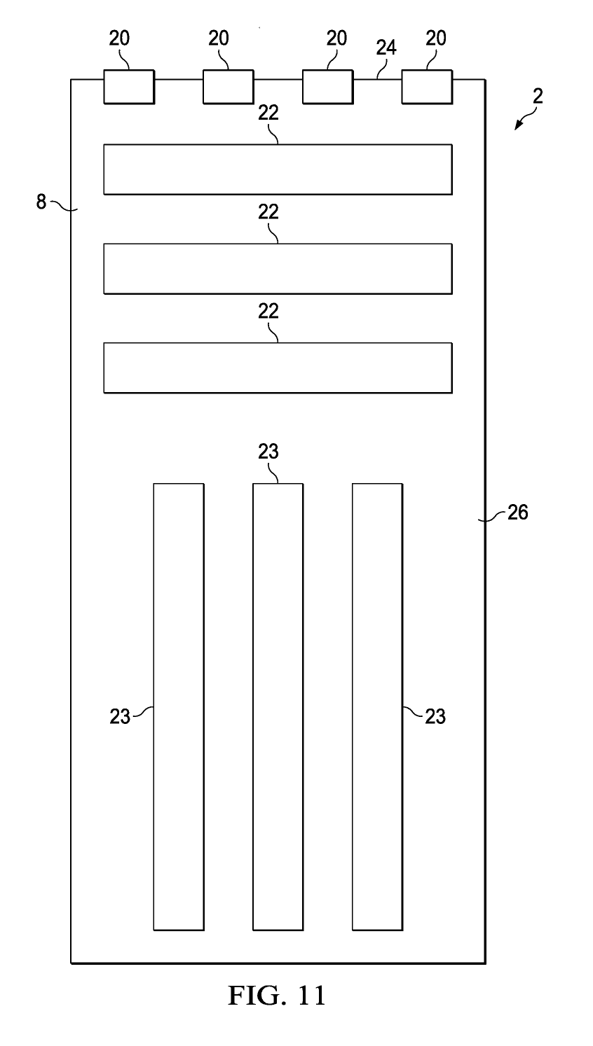

Referring to FIG. 11, the number 8 represents a lightweight, low-density and highly-insulating panel covering “pocket” 8 as shown and described in FIG. 2. The number 20 represents one of four C-clips that have been put into an operative position to secure the open edges of panel “pocket” 8 after it has been pulled onto (and surrounds) the panel frame 4. The number 22 represents one of three highly-insulating, NON-STRETCHY strips of material that has been sewn or affixed, in a crosswise position, onto the top or upper side of the panel 2 of the present invention. They were sewn, attached or affixed onto the panel covering “pocket” 8 before it was pulled onto and over the frame 4. They can be strips of a very thin material so that they do not extend very far above the surface of the panel covering 8; or, they may be made of a thicker, more “cushiony” material and thus they may be slightly raised or offset from the main panel covering 8. This may give the finished panel 2 a “ribbed” look or effect; and it could serve (in some applications) to enhance the overall cooling and/or protective qualities of the panel 2 of the present invention. The number 23 represents the same, or a different, type of highly-insulating, NON-STRETCHY strips of material that, in this case, have been sewn or affixed to panel covering 8 in a lengthwise position on the upper side of the new panel 2. Finished panels 2 may have such strips 22, 23 affixed in an alternating pattern of several “crosswise” strips 22 then several “lengthwise” strips 23, or all such NON-STRETCHY strips used on a single panel may be positioned in the same direction. Alternatively, they could be placed on and affixed to the panel 2 in a diagonal, or “bias”, direction if desired. In place of the “strips” 22, 23 or elongated rectangular shapes shown, the NON-STRETCHY material that may be integrated into the panel 2 of the present invention may be in the shape of squares of any suitable size, or sewn circles/dots made of such a material although squares and dots are not shown in FIG. 11. Many types of materials, in various shapes, may be added to either side of the panel 2 of the present invention for performance, durability, aesthetic reasons, etc. And even with such NON-STRETCHY sections or components 22, 23 added to the panel covering material 8, the finished panel 2 will still retain enough capacity to stretch in order to be self-tensioning when pulled onto and over the frame 4 of the panel 2 of the present invention.

In other or improved aspects of the present invention, the unique, self-tensioning modular panels 4 for protecting structures (as well as the self-tensioning modular panels for free-standing uses) described herein preferably comprise a suitable frame 4 (which may be an extruded or other frame), along with a panel covering 8 that is stretchy (and can be porous) that is capable of being pulled over the frame 4 then secured in place around it (thus hiding the frame from view). The panels 2 are very lightweight, durable, emissive, cost-effective, and helpful in many different applications. Many materials may be selected to comprise not only the frame 4 and the panel covering(s) 8 but also any mounting brackets or frames, anchoring components, baseplates, panel connecting(or protecting) components, fasteners, hardware, or columns that may be needed for securing the panel(s) in place.

The frame material may be any material strong enough to serve the intended purpose of supporting the covering that is being pulled over/around it (thus allowing for a natural self-tensioning of the covering) and giving the finished panel its shape. It may be solid or hollow, rounded or square-shaped. It may also be capable of floating. It may be rigid, which allows the finished panel 2 to remain flat (or in the case of a more flexible frame material being used, the finished panel 2 is capable of bending). Alternatively, a more rigid frame material may be bent, or forced into, a curved shape 40 before any panel covering 8 is pulled over the frame 4. In such a case, a curved, finished panel 2 need not have a framework that is made from only flexible material; it may instead have the stretchy panel covering 8 pulled onto and over a frame 4 consisting of a rigid material that is already curved before the covering 8 is put in place. Many methods of construction may be employed to create suitable frames 4 for these panels 2. These methods include an extrusion process involving any type of material that can be extruded.

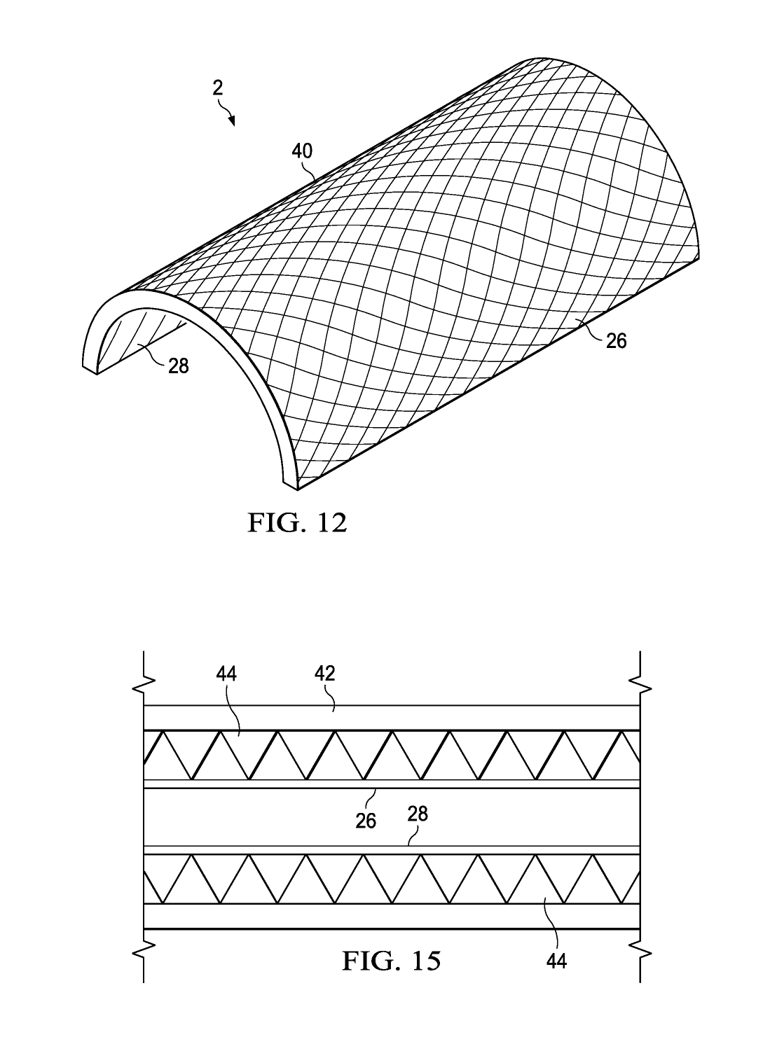

An example of a curved panel 2 provided by the present invention is illustrated in FIG. 12. Because of the preformed or pre-set or permanent curvature of the panel frame 4, all or at least a portion of this panel 2 has a curved shape 40 which extends over an arc of curvature of at least 30°, at least 45°, at least 60°, at least 90°, at least 120°, at least 150°, at least 180°, or more.

In regard to panel coverings 8, they may be made of materials such as shade fabric, shade cloth, privacy mesh, windscreen mesh, hail net, impact netting, or visual-barrier netting. Examples of suitable stretchy materials include, but are not limited to, shade fabrics made of polyethylene, polyester, or polypropylene, AlumiNet, stretchy material combined with non-stretchy elements, hail netting, privacy mesh, or any other similar product.

Concerning “shade boxes” which have been invented to surround rooftop air conditioning units, the panels 2 of the present invention are a much improved solution for providing valuable shading to such units. Earlier shade boxes were meant to be supported on cabling, and were comprised of a single layer of shade fabric clipped to the cables. One or more of the panels 2 described herein are particularly well-suited for shading and protecting these HVAC units (whether on a rooftop or alongside a building) as well as any other equipment or rooftop features such as elevator equipment, rooftop penthouses, patios, etc. Besides providing much needed shade, especially in hot climate zones, these panels 2 also serve as a new type of hail-guard solution. Even our earlier, less durable prototype panels were impact tested at Texas Tech University with excellent results. The improved panels of the present invention represent a further significant improvement over the earlier panels. Using “outrigger” brackets or frames that are securely attached to the HVAC platform, the panels 2 disclosed herein can be installed completely around the unit (stood-off at a distance that ensures sufficient air flow) or on any combination of sides. In one preferred type of installation, one panel 2 is installed to the east of the unit, another is installed just to the west, and a third panel across the top (all three joined together and to the anchoring outriggers). In this way, sunlight is blocked or filtered in the morning hours, at midday, and all afternoon, as well. This strategy is preferable when using the flat self-tensioning modular panels 2 described herein; however, curved panels 2 may also be utilized for this purpose. If creating curved panels 2, the frame material need not consist only of flexible material, but rather may comprise of a more rigid material that is made to curve or bend (and would keep its shape following the bending process) before the panel covering(s) 8 are put in place surrounding the frame 4. In an HVAC unit protecting application, a curved panel 2 could be preferable to some customers, and the curved HVAC protecting panels 2 could also be positioned to block or filter harsh sunlight from morning through evening hours. These rooftop equipment cooling/shading panels 2 (either curved or flat; completely or partially surrounding the equipment) may also have water mist (or a water drip system) applied. But this is optional, as the shading produced by these panels 2 is very effective even without the misting feature.

The panels 2 disclosed herein, when used in this application, will perform much better than the previously envisioned shade panel systems for rooftop uses. Each panel 2 has twice the shading capacity, and offers twice the impact protection, of previously used or envisioned panels or system of panels. Additionally, it is very windy on rooftops; and the panels 2 of the present invention are virtually windproof in regard to the panel covering 8 not being blown off the interior frame 4. They have withstood wind forces up to 80 mph in demonstration installations with the panel coverings 8 remaining completely intact. Therefore, the panel 2 systems described herein represent a significant improvement in rooftop equipment protection.

Another recent discovery involving air conditioning in heavily populated, hot locations is that excess heat rising from so many HVAC units is keeping temperatures from cooling off overnight as they typically should. This adds to the Heat Island Effect of urban areas, and it exacerbates the problem because the higher the temperatures, even overnight, the more air conditioning is required for comfortable indoor environments. A team of researchers at Arizona State University studied this problem, and the article “Cooler on the Inside, Hotter on the Outside” was published on the internet on May 25, 2014 at www.enn.com and accessed Jun. 11, 2014. The panels 2 of the present invention, especially those employing the water misting options, beneficially help reduce the amount of the excess heat rising from the rooftop equipment. In this application, when installed in an operative position around such rooftop a/c equipment, they may be misted during the evening and overnight hours to effectively neutralize that heat that is helping to keep urban areas such as Phoenix so hot.

Also, in regard to rooftop applications for the panels 2 of the present invention, rooftop electrical lines, conduits, and raceways have been found to gain a considerable amount of heat during summer months (and, in some hot locations, for most of the year) when they are installed along the surface of, or are in contact with, roofing materials. Recent changes have been made to electrical codes that state that, if such equipment is in direct sunlight, conduits must be raised above the roof surface (or alternatively, in some cases, must even be relocated underneath the roof surface). Provided here is the link to a site that describes the problem and what is being done to solve it: www.iaei.org/magazine/2009/03/effect-of-rooftop-exposure-on-ambient-temperatures. The panels 2 described herein, when fabricated and installed in a configuration to match or follow the pathways of such rooftop electrical lines, can very effectively block the sunlight that is causing the wiring to heat up. Panels 2 can be designed and made that are just wide enough to give sufficient shading to the conduit or raceway below (or a little wider to create a microclimate of shade to the surrounding nearby areas of roof surface), and they may have additional insulating material on the inside of any or all of the panels 2 to ensure just the right level of solar heat blockage. They may be supported and anchored in various ways, depending upon the layout of the electrical equipment and/or the types of rooftop structures that exist and which may serve as attachment points. They may be attached securely to patio blocks or pavers (to provide a little height if needed) on each side of a raceway-covering shade panel, or they may even be held in place by weighted bags (such as sand bags) that are designed to apply just the right amount of weight to hold these panels 2 in an operative position to provide cooling shade to all, or selected, stretches of rooftop electrical equipment (including wiring that is transporting electricity generated by solar/PV panels on a rooftop). For brand new construction projects, any type of anchoring brackets (or other strategy) may be designed into the project from the beginning in order to properly support and hold these new electrical equipment protecting panels 2 in an operative position to do their intended job. The panels 2 described herein are very lightweight, durable, non-flammable, and cost-effective; therefore, they are very well suited to help solve this problem (i.e. overheating of electrical conduits and wiring on sunny rooftops).

Another way that the panels 2 of the present invention can be used on rooftops is to direct rainwater. The panels 2 can be installed at any angle (preferably at least 15° from horizontal and more preferably more than 30° from horizontal or 45° from horizontal) in relation to the roof surface and/or to each other (for example, in a zig-zag pattern, or in rows of panels tilted in the same direction). When tilted, most water hitting the panels simply runs down the panel covering and does not drip through the covering—even without having had the panels specifically “waterproofed”. Thus, with a system of gutters installed in combination with the panels 2 of the present invention (with the guttering placed directly beneath the lowest edge of each panel, for example) these new panels 2 can be instrumental in helping direct rainwater to wherever it is desired. The panels may be installed upon any type of support brackets (or even upon several types of solar panel “racking systems”) with any type of water-collecting feature added below. Also, on or alongside of “building walls, the presently-described modular panels 2 can serve as “rainscreens” to direct rainwater to an area such as a rain garden (or toward a collection tank such as a cistern). Collected rainwater is often used for landscape irrigation needs and is part of a sustainability plan for many building owners. Therefore, used on rooftops or walls, the panels 2 described herein can be very helpful in the collection of rainwater. Such collected and saved water can even be used to supply any water misting system (or “drip” system of water delivery) that may be utilized along with the panels 2 of the present invention to enhance their cooling capabilities, as previously described. Collected rainwater can also be saved at roof level (especially in the case of a newly-designed building that is engineered with rooftop water storage in mind) to later be used in the misting of these new panels at times when the water misting would be most beneficial.

It has been previously discussed that the panels 2 of the present invention can be placed over rooftop skylights. The intended purpose is to stop unwanted heat gain while at the same time allowing beneficial, filtered or diffused light to still enter the facility through the skylight. Now, there are new concerns about accidental falls through skylights, and steps must be taken to prevent such accidental falls. The new modular panels 2 described herein are extremely well-suited for this solution. The panels 2 are very strong (especially when multiple fabric or mesh layers are fabricated together to make up each side 26, 28 of the panel covering 8 or when applying more than one panel 8 covering over the same frame 4). Positioned and anchored properly over skylights, they can prevent a person from falling through those skylights (or any glass, daylighting system). The panels 2 can be “stacked” in this application (and others). Properly secured stacked panels 2 can definitely serve a protective role in regard to skylight fall protection. Stacked panels 2 (or simply panels 2 that are not stacked) can be installed over the entire skylight, or around the perimeter of the skylight at any desired height (as a physical and visual barrier for rooftop workers). The panel coverings 8 for this use can be brightly colored and/or they can have warning messages printed upon them (by any means of printing that is available).

Recently, also, there have been reports of hailstones crashing through a retail store's rooftop skylights during a severe weather event. The panels 2 of the present invention, if in place covering those skylights, would have prevented that hail damage. The impact testing by Texas Tech University mentioned above was done using 2″ and 2½″ ice balls that were fired from an air cannon (traveling at a velocity of between 78 and 99 mph) at an earlier version of the presently-described panel. Those prototype panels 2 were very successful in preventing hail damage to the roofing material that was behind the panels 2, and the new, self-tensioning modular panels 2 provide a higher level of protection (not only for roofing products, but also for skylights and for HVAC units, as discussed above). In recent years, there has been increased awareness of property damage due to severe weather events along with discussion regarding ways to help make homes and businesses more “resilient” to such damage. In an article by the Insurance Institute for Business and Home Safety (IBHS), which was posted on Oct. 17, 2012, it is stated: “The dramatic rise in homeowners insurance claims attributed to severe weather events in Oklahoma demonstrates the need for residents to take action to make their homes more resilient to weather-related damage . . . ” The article further states, “Direct losses due to weather-related property damage in Oklahoma totaled more than $1 billion in 2011, according to the Oklahoma Insurance Department, which is an increase of 187% for the period from 2005-2011. A majority of that figure was the result of severe weather events—hailstorms, floods, severe thunderstorms, tornadoes, wildfire and a 5.6 magnitude earthquake that struck the Sooner state in 2011.” Although the article did not list how much of that damage was caused by hail strikes alone, it is clear that hail impacts cause much damage to roofs, rooftop equipment, and skylights—not only in the state of Oklahoma, but in many, many other areas of the country, as well. The presently-described panels 2 are particularly perfect for flat or low-sloped roofs and for flat-roofed commercial structures, they are perfect. It is important to remember that these panels can be configured to shade (and also protect) entire walls of structures or selected portions thereof. Hail, as well as other wind-blown debris, often strikes the sides of structures (causing damage to siding, windows, etc.). Therefore, due to their exceptional protective qualities, the panels 2 described herein are excellent hail or impact protection panels that serve to improve the resiliency of many types and sizes of structures.

Another area of growing concern involves birds striking buildings—primarily tall, glass facade offices, hotels, or other buildings. Birds perceive the reflected sky and/or surrounding vegetation as something through which they can fly, thus many bird impacts to structures (especially along migration pathways) cause the birds to be injured or to die. An organization called the American Bird Conservancy is, and has been, working diligently to help alleviate the problem of excessive bird strikes. An article found at www.buildings.com—titled “Bird-Friendly Building or Avian Abattoir? Sustainable Facilities May Be Deadly for Birds” and posted on Oct. 1, 2014—details these concerns and possible methods of helping reduce the number of bird strikes to such buildings. Etching the glass, applying various types of window films inside or outside the glass, use of interior blinds, applying strips of tape (or even tempera paint) to the glass have all been tried with varying levels of success. Sections of a netting material (attached a few inches from the glass on the facility's exterior and fastened with suction cups) has also been tried by some building owners (to help soften or slow down a bird's impact). Therefore, the panels 2 of the present invention can be installed for this purpose, and any type of frit or dot-like pattern can be printed onto the panel coverings (using whatever materials, or color of materials, desired) before being installed in an operative position to shade the side or sides of glass structures while also provide excellent bird-strike reduction. The panels 2 described herein normally to not create a glare problem, but all materials used in such an application will be selected that are non-glare producing and non-reflective of the surrounding environment. The panel 8 covering that is comprised of both stretchy and non-stretchy elements described herein is especially useful in this application, because dots, squares, stripes, or any arrangement or pattern of the non-stretchy material(s) made a part of the panel covering can be non-reflective. It can also be slightly porous (or breathable) itself, and it may also be a perforated material that is non-stretchy. There is another benefit of possibly choosing the panel 2 of the present invention for this application: when permanently installed on glass building exteriors, even if only on the areas of a facility having the greatest bird strike concern, these panels reduce the amount of (or the brightness of) the light shining outward from the building's interior. Most tall buildings, including glass buildings, remain lit up at night due to late night office workers and/or custodial workers occupying the building (or simply to beautify the city's skyline at night). Birds are drawn to light, and again may fly right into the glass. The panels 2 of the present invention can soften and diffuse the interior light to a certain extent, and varying levels of light diffusion can be created depending upon the exact materials selected for panel coverings 8. Many colors of fabric or mesh panel covering materials (as well as many colors of any non-stretchy panel covering components, if that type of panel covering is desired) may be selected; and adding color to a city's nighttime skyline is now a popular trend. Thus, beautiful colors or color combinations can be selected for these new panels 2, and they may be lit by floodlights (or they may be “back-lit”) anywhere on the sides or on the rooftops of city buildings, parking garages, etc. Further, these panels 2 create a cool environment for glass walls (instantly “cool walls”) and will be very beneficial when installed, for instance, along west-facing walls that receive large amounts of heat and/or bright light from the sun (causing discomfort or visual stain for building occupants), especially in regard to glass facades that do not have glare-cutting window films installed. With the panels 2 of the present invention in place on the building's exterior wherever needed or desired, the use of interior blinds, shades, and/or films may not be necessary.

Still referring to the protective nature of the panels 2 of the present invention, they can serve as a new type of hurricane-protection product. As average temperatures in various parts of the world have increased, so have ocean temperatures. Oftentimes, hurricanes have also increased in strength along with this rise in ocean surface temperatures. In recent years, and in some cases, the occurrence of hurricanes has been more frequent (along with the tornadoes that spin off from them at landfall) and the power of the associated wind speeds has often increased, as well. According to most climate scientists, this problem is serious; therefore mitigation strategies are needed, as well as better protection for people and properties in coastal areas. Many strategies have been utilized to help protect properties from hurricane wind damage. The most likely ones are, and have been, use of better home construction methods (including use of better roof attachment hardware), installing more wind-resistant home components (such as windows, patio doors, and/or garage doors), installing permanent or temporary hurricane shutters or panels (such as solid metal hurricane panels or even “Bahama” shutters or panels), or by simply covering windows and glass store fronts with plywood (often at the last minute). People sometimes put themselves at risk by staying to install these protective products when they should be evacuating, so the easier the product is to handle and install, the better. The problems with using plywood include the cost of the plywood itself, which normally increases in price just before a hurricane is projected to hit (because many people are purchasing the plywood at once and there is usually a shortage of the most protective, recommended type). Another problem with using plywood to protect glass is the marring of the structure around the glass caused by either nailing or screwing the plywood to the structure. Also, a significant problem with using plywood in this way is what to do with the wet plywood once the property owner takes it down. Once plywood gets wet, it will almost invariably warp whenever it is removed. As a result of this problem, a lot of plywood is not reusable, thereby creating a lot of waste, a lot of plywood being sent to landfills, and much money spent on a very temporary solution. Further, in regard to plywood or to heavy steel hurricane panels, many homeowners and building owners (especially those with any type of physical disability), can find it very difficult if not impossible to hold, handle, and install these types of protective products simply due to a lack of physical strength and the fact that they may not have a close friend or relative nearby to install them as hurricanes are approaching.

The use of the new, inventive self-tensioning modular shade panels 2 are of benefit as an alternative way to protect windows and other glazed areas of buildings, patio doors, garage doors, rooftops (and more) during hurricane or tropical storm events. Utilization of these modified panels 2 (whether permanently installed or intended to be temporary protection only) offers as good, if not better, protection for structures by blocking, stopping, or dampening the impact of wind-blown projectiles. These panels 2 are lower in cost than many hurricane-protection options, and they are much easier to handle, in most cases. Materials chosen for panel coverings 8 can be multi-layered before fabrication, or alternatively, multiple panel coverings can be applied to the same panel frame 4 at the time of assembly. Very strong fabric and mesh products exist in the market that will be suitable for the hurricane-damage protection panels of the present invention. For example, such materials exist (from a U.S. manufacturer) that are known as “Mono-Mono” and that have an ASTM Bursting Strength (ASTM D3786 test) of between 417 and 469 psi. These, and other strong materials, either alone or layered one over another, are preferred panel covering materials 8 for this application. However, other fabric or mesh material options that are less strong individually may be utilized due to the fact that they may be layered to the desired level of strength. These combinations of different fabric or mesh layers (including commercially available hail netting that may be also added inside or outside any panel) can provide considerably more strength to the panels 2 being prepared for this application—whatever level of strength is needed based upon local weather risks and the level of protection that is desired to protect the structure or structural element behind or below the installed protective panels. Additionally, as in the details given above regarding hail impact protection, the panel covering(s) 8 of the presently-described protective panels 2 can also comprise stretchy and non-stretchy elements.

Now, regarding the frame 4 on the inside of each of the presently-described panels 2, it can be reinforced with any number of cross-braces 7 (which can be built into the frame in any direction and with any level of spacing between them). Also, other materials may be used in, or added to, the framework such as metal mesh, perforated metal products cut to fit the panel's interior, etc. Insulation materials may be added inside all (or any selected) panels 2 as well, and such insulation materials may serve an important function to further help block, deflect, dampen, or absorb any force from a projectile hitting the panels 2 of the present invention when in use in this application.

Installing the protective panels 2 of the present invention may, in some instances, include the utilization of pre-positioned anchors or brackets (on buildings or other structures) to allow for quick and easy installation and eventual removal. Mounting hardware for these modular, protective panels 2 will vary. Use on windows of a home will not require the very same anchors, hardware, or brackets as will panels 2 designed to cover larger, more expensive commercial building windows, glass walls, or rooftops. Mounting brackets, hardware, or anchoring systems may be prepositioned on buildings long before hurricane threats arise (before typical “hurricane season”). Then they will be ready to quickly receive the protective panels 2 of the present invention at any time needed. Mounting hardware will also be different if, in some cases, the panels 2 are “stacked” one panel 2 in front of (or in a rooftop application, below) the others. Stacking of panels 2 will provide a much stronger solution and protect the protected surfaces much more than a single panel 2. Special edge-protectors 42 made for these stacked panels 2 can hold two, or even more, panels 2 per edge-protector 42. They are engineered to securely hold the panels in place in an operative position, at any desired angle from the structure being protected, during any expected or planned for wind events. The special edge protectors 42 can join one panel 2 to the next (even regarding panels 2 that are not specifically stacked) but they do not need to join panels together. They can simply help secure the panel covering(s) 8 around the framework 4 of each panel 2 and make the overall panel 2 stronger while providing a nice, finished appearance. If they do not connect panels 2 one to another, but are still used to attach each panel 2 to a wall, roof, or other surface, then can be securely attached to the structure by themselves in an operative position that allows the protective panels 2 to do their job. Alternatively, panels 2 with edge-protectors (or without them) can also be stood-off a predetermined distance from the surfaces they are protecting and still hold up well under most expected environmental conditions. In fact, providing a bit more distance between the panels 2 and the surfaces that they are installed to protect may prove to be preferable in some cases. The protective hurricane-protection panels 2 may also be curved; not only to conform to a curved surface that is being protected (which could be the case), but rather to give a different look to the lightweight protective panels when installed or for other reasons (for example, a very strong, curved panel 2 can have advantages in stopping or deflecting wind-blown projectiles). The panels 2 of the present invention therefore, will perform very well (in various forms, various sizes and shapes, and made from a number of suitable materials) during hurricane, tropical storm, or severe weather events.

An additional protective use for the panels 2 described herein is for adding more impact protection on/around above ground safe rooms. Positioned securely and properly around safe rooms, while still allowing for adequate entry and exit by people and their pets, the panels 2 of the present invention will serve, again, as a type of sacrificial barrier system. They would receive some of the force of windblown debris or objects that would otherwise impact the safe room full force. They can be integrated into the safe room design at the factory, or can at some point, be added as a retrofit option for safe room owners to choose. They could make use of any type of strong anchoring or mounting system of brackets, large fasteners, and/or base plates as may be required to attach them or anchor them in a protective position around safe rooms. These anchoring or mounting systems could be slightly flexible rather than totally rigid. They could also have springs or any type of soft, cushiony, impact absorbing material or device installed between them and the outer surfaces of the safe room. They may not be needed on all sides of a safe room in order to add more protective qualities to any type of safe room, whether the safe room is made of steel, concrete, or other materials. The presence of the panels 2 of the present invention that surround, or partially surround, various types of safe rooms could allow for slightly less thick (or possibly lighter) materials to be used to build those safe rooms—all the while giving the same or better level of impact protection and safety for the occupants inside.

Other building-related uses for the new, self-tensioning modular panels 2 and panel systems include (but are not limited to) the following: retail buildings and garden centers; convention and event centers; shopping centers; grocery stores; manufacturing buildings and assembly plants; modular buildings; metal buildings of any type or size; any type of data center; mobile offices; construction trailers; schools and portable classrooms (especially schools that are wanting to achieve “green schools” recognition); sunrooms and atriums; shipping container buildings (both residential and commercial); “Tiny Homes”; disaster-response housing/temporary housing; casino and/or resort facilities; apartment units, townhouses, lofts and condos; restaurants; places of worship; and many other types of structures where people live or work. These new panels may be able to be incorporated into lightning protection solutions for all types of buildings and other structures. Uses for the panels 2 meant to be just outside various types of buildings, and not necessarily attached to buildings, include: carports, patios, decks, pergola toppers, outdoor kitchens and living areas; porches; workshops and garages; fencing; courtyards; playgrounds; golf courses; tennis courts; swimming areas; smoking areas; prison yards; walkways; parking areas; animal shelters such as dog runs etc. (When installed over walkways and parking areas, the panels 2 instantly help create “cool pavements”.) They may also be put into use at parks of many kinds—such as water parks, amusement parks, park picnic shelters, etc.—and they may also be very useful at pavilions, outdoor concert stages, farmers markets, flea markets, and similar places where valuable sun-protection is needed. They can be used to create very effective and easy-to-install outdoor free-standing cooling stations. Such cooling stations can be fixed or mobile. (The panels 2 of the present invention have been installed as a modular, free-standing cooling station at a fund-raising event, and they have also been found to be quite useful when installed around ice-making equipment at a golf course.) Mini-storage structures will also benefit from the panels 2 of the present invention although people do not live or work inside them. The presently-detailed panels will serve to moderate the interior temperature of such un-air-conditioned storage units so that the contents of those units are better protected by not getting excessively hot—especially in areas that experience long hot summers or those that have warm weather all year-round.

Another unique application for the modular shade/mesh panel system relates to water conservation. The state of California has been experiencing a water emergency, although recently they have received some relief in the form of much-needed rainfall. This shortage of water, and resulting drought, is caused by several factors. Reduced snowfall in the mountainous regions of the state has been occurring, which results in less snow melt in the spring (therefore less fresh water runoff being available to replenish regional water tables and reservoirs). Reduced rainfall has also contributed to the problem. Population growth, along with agricultural and industrial water usage, have all placed increased strain on water supplies. Water restrictions for homes and businesses have become the norm in many areas of the state (and other states that are experiencing drought conditions, as well). Reduced rainfall and persistent drought has caused many types of plant life to dry out and die. This has resulted in a growing number of wildfires in such drought-stricken areas. Fighting all these wildfires has also reduced the amount of available fresh surface water. Evaporation of surface water contained in streams, rivers, canals, reservoirs, and even the aqueduct system(s) also play a major role in the loss of available water resources.

The reduction in the amount of surface water available for use by humans, livestock, and farming operations is not confined to California by any means. Texas has experienced similar problems, as have many other states in the U.S., especially the southeastern states of Alabama and Georgia. (An Associated Press report published in the Tulsa World newspaper on Oct. 29, 2016 that was titled, “Drought across South kills crops and threatens herds” gives a very good overview of the problems that area of the country is currently experiencing.) According to that article, serious drought “has spread . . . across 13 southern states, from Oklahoma and Texas to Florida and Virginia, putting about 33 million people in drought conditions, according to Thursday's U.S. Drought Monitor.” Additionally, many other countries around the world are facing the same problems due to persistent drought conditions. In the future, the scarcity of fresh water may ultimately, affect almost all life forms on Earth. Many people are working steadfastly to find reliable ways to conserve precious water supplies, for the need is, in many locations, urgent.

The primary factors that cause surface water loss (through natural, not human-caused, reasons) are solar heating and warming of the water (causing evaporation) and wind losses. Utilization of the modular shade/mesh panel systems for reducing evaporative loss of water from rivers, canals, reservoirs, lakes and other bodies of water addresses both problems with one system. By keeping surface waters cooler (by preventing the solar energy from reaching the surface of the water, or by greatly reduce the amount of direct sunlight that is able to reach, and heat up, the water) evaporation of the water can be reduced by a substantial amount. The modular panels 2 and panels systems described herein (when installed in an operative position on, over or across such surface water areas) can keep the wind from reaching the surface of the water, thereby again, helping to conserve precious water supplies. Because each shade/mesh panel 2 is modular, it can shade and cool water surfaces wherever needed while simultaneously allowing for the ability to leave open channels anywhere they are needed for navigation or other purposes (such as fire-fighting efforts, since helicopters often need to reach surface water areas to scoop up water to deliver to a wildfire location).

The modular panel 2 of the present invention can be supported just above the water surface by a system of buoys (or any type of floatation device or structure). Alternatively, the modular panels 2 can each be made with a framework that consists of a buoyant material so that a system of at least one modular panel can float directly on the water's surface without the aid of any buoys or floatation device(s). The modular panels 2 described herein can also be attached to any type of support framework (or subframe) that is made of suitable material capable of floating, such as wood. The modular panels 2 are very lightweight, therefore they would not add much weight to such a water-protecting system. Any, or all, of the modular panels 2 can be connected individually, by any method that will maintain strength, uniformity, and reliability, to such a subframe (or by many other means, as dictated by each project or as specified in regard to such an assembly of panels) if desired. Panels 2 can also be held in place, individually or in groups, by an anchoring system comprised of at least one anchor that is submerged and is sufficiently strong enough to hold them in place under expected environmental conditions. As many anchors as needed may be used. Panels 2 and panel systems may also be secured in place, especially in installations where the body of water is narrower, by anchoring points located on/along opposite sides of the bank or shoreline. A series of UV treated ropes, bungee cords, cables, or any other type of “tie-downs” could serve to hold the panels 2 in the proper position while they are protecting that particular area of surface water. Panels 2 need not float directly upon the water, however, to be very effective. They may be mounted on, or securely attached to, any type of spanning framework that is engineered to reach across the water to the other side—especially in the case of relatively narrow streams, irrigation canals, etc. In the case of aqueducts transporting water supplies, as well as the above-mentioned narrow bodies of water such as canals, the curved modular panels 2 of the present invention may be preferable choices for protecting them and helping prevent evaporative losses (especially when aqueducts and/or canals must transport water long distances across very warm or hot areas). In other water-conserving applications, the panels 2 of the present invention may be used at fish farming operations to simultaneously save water, to provide a much cooler water temperature for the fish being raised (and amphibians, water reptiles such as turtles, or other cold-blooded creatures that may inhabit the waters of such an operation), and to provide a physical screen or barrier that would keep predators such as birds from getting to the fish. Reducing the amount of direct sunlight that reaches the water can also help reduce algae growth (that, if allowed to get out of hand, can reduce the amount of oxygen in the water, thereby harming the fish population).

Now, in regard to possible panel fabrication changes and/or addition of complimentary components, the following are some, but not all, additional improvements: The number of seams that need to be sewn to make pocket or tube shaped panel coverings can easily be reduced by one each (when a fold is made along one side of the panel 2 covering instead of cutting the material along that side). In some cases, if the material is wide enough, two folds can be made (and then only one seam would need to be sewn—to close one end—in order to create a pocket-shaped panel covering 8). Panel coverings 8 may also be able to be made that have no seams at all, but rather are made in one continuous tube shape (in a way similar to how mesh or netting produce bags are made). In that instance, they would be tube-shaped from the very beginning They would be easily pulled over and around a suitable frame 4 and secured on both open ends by various means—without ever having to sew a seam. Also, in regard to panel coverings 8, it is realized that non-stretchy elements do not have to be reflective. They can instead be non-reflective and non-glare producing. They may also be slightly porous in nature (while still remaining non-stretchy) and they may have small perforations in them, as well (again, while still remaining non-stretchy). They may still be slightly raised in relation to the main panel surface, and they may be applied to the panel covering 8 in any type of pattern (such as a pattern that would be valuable or helpful in reducing bird strikes to building facades).

In regard to frames 4, the panels 2 of the present invention do not have to have frames that are only bent or preformed (or that are comprised of the bent/swedged corners and/or bent/swedged long end pieces, although those ways of making the panel frames 4 still work in most applications). But, it is envisioned that extruded frames 4 of various materials and widths would, in many cases, serve very well as frames for these new panels 2. The extruded frames 4 may later be cross braced, or not, and they may also be curved. Any type of rigid material, that will hold its shape after being curved, may be suitable for supporting the panel coverings 8 of the present invention. Therefore, a flexible frame material is not a necessity in order to produce a curved frame 4 and resulting finished panel 2.

In regard to possible panel connecting components, any type of connector or spacer can be utilized between, along the edges of, or on the corners of any panels 2 if desired. Therefore, a new edge-protector 42 has been developed for use in some, but not for all, panels 2 of the present invention. They are not required for the panels 2 to serve many useful purposes successfully, but they may help to hold and support the panels 2 in some applications (while in other applications, they may simply supply a more professional or “finished” look to the panel or panels 2). The panel edge-protectors 42 may be made of any suitable material that is strong enough to serve the purpose of giving extra support to the panels 2 described herein, and they may have teeth- or comb-like features 44 that have fabric-grabbing capabilities in order to help hold themselves in an operative position to protect the side edges of the panels 2. They need not be included on or along all sides of any panel 2, but may be included on even one or two sides of certain panels 2, depending on the application and whether panel edge protection is needed or desired. The edge-protectors 42 may also have features built in that facilitate the joining of one panel 2 to another, although the joining of panels 2 in this way is only an option and not a necessity. They may have rings, hooks, eyelets or other similar features included when the panel edge-protectors 42 are made; and these features may be used (along with various tying or lacing materials) to connect the edge-protectors 42 (that already are surrounding at least one edge of a panel 2 of the present invention) to at least one similar edge-protector 42. When the edge-protectors 42 presently being disclosed are in place around the edge or edges of any given modular panel 2, it is possible that UV-treated thread will not be required when making the panel coverings 8 because the panel edge-protectors 42 would keep sunlight off the panel edges that previously always had sunlight striking them. Also, another possible time-saver with the use of edge-protectors 42 is that, normally when panel coverings 8 have been made, materials have been placed together with “right” sides facing each other, stitched along the seam lines, then turned so that the “right” sides are facing outward and the seams sewn become hidden from view. Seams are on the inside of the panel covering 2 then, where the panel frame 4 would be inserted. Alternatively, if panel edge-protectors 42 are utilized, seams will not have to be hidden (therefore panel coverings 8 will not have to be turned in order to hide them from view) because the edge-protectors 42 will cover up any seams that are made in creating the panel coverings 8 as soon as they are put in place around the perimeter of the panel 2 (or around any selected side thereof). Also, panel coverings 8 can be fabricated with “right” sides facing outward at the beginning (i.e. with “wrong” sides together) with no need to turn the panel covering at all. This saves valuable time during the fabrication/assembly process. The edge-protectors 42 do not need to completely surround a frame's perimeter. They can serve as a helpful, protective feature on any side or sides of any modular panel 2 of the present invention; and they can be useful in some applications in helping make the panels 2 stronger, more resilient, and/or in the connecting of panels 2 together if needed or desired. Also, in some instances, depending on the type of panel coverings 8 being used, an edge-protector 42 can successfully close and secure an open end 24 of the covering 8 after frame insertion. Therefore, it can replace any hook and loop fasteners 9 and/or C-clips 20 that have been above that were examples of ways to close and secure the open end (or ends) 24 of the panel coverings 8 around the frame 4 once the frame 4 was inside. Thus, this optional function of the modular panel invention can save time, money, or both when constructing the panels 2. The edge protectors 42 may also have magnets, or magnetic strips, built into, or added to, the portion of the edge-protector 42 that will or should come in contact with an edge-protector 42 on another modular panel 2 that is equipped with similar magnets (or that has been made magnetic in some fashion). Use of magnets on edge-protectors 42 is optional, but could be helpful in some applications if cost-effective to do so. Edge-protectors 42 are also capable of holding more than one modular panel 2 of the present invention, as in the case of a stacked panel application.

Whereas, the devices and methods have been described in relation to the drawings and claims, it should be understood that other and further modifications, apart from those shown or suggested herein, may be made within the spirit and scope of this invention.

What is claimed is:

1. A modular panel for shading, impact and wind shielding, safety protection, and water and energy conservation comprising:
a closed-loop frame having a permanent, substantially rigid shape in which at least a portion of the closed-loop frame is curved in an arc of at least 15°;
a covering having a first layer, a second layer, a closed peripheral portion where the first layer and the second layer are joined, and an open peripheral portion; and
the closed-loop frame being fully received in the covering through the open peripheral portion and the open peripheral portion being closed to form the modular panel wherein (i) the closed-loop frame is fully contained in and concealed by the covering, (ii) the first layer of the covering forms a first side of the modular panel, (iii) the second layer of the covering forms an opposing second side of the modular panel, (iv) the first side of the modular panel is spaced apart from the second side of the modular panel, and (v) the covering conforms to the permanent, substantially rigid shape of closed-loop frame so that the first and the second sides of the modular panel, or at least corresponding portions thereof, curve together in an arc of at least 15°.

2. The modular panel of claim 1 wherein:
at least a portion of the closed-loop frame is curved in an arc of at least 90°;
the first and the second sides of the modular panel, or at least corresponding portions thereof, also curve together in a corresponding arc of at least 90°.

3. The modular panel of claim 1 wherein the covering comprises a stretchy shade fabric material.

4. A method of reducing evaporation losses from a body of water comprising the steps of:
a) forming one or more modular shading panels, each of which comprises a closed-loop frame and a covering wherein
1) the covering comprises a first layer, a second layer, a closed peripheral portion where the first layer and the second layer are joined, and an open peripheral portion and
2) the closed-loop frame is fully received in the covering through the open peripheral portion and the open peripheral portion is closed to form the modular shading panel wherein the closed-loop frame is fully contained in and concealed by the covering, the first layer of the covering forms a first side of the modular shading panel, the second layer of the covering forms an opposing second side of the modular shading panel, and the first side of the modular shading panel is spaced apart from the second side of the modular shading panel; and
b) placing the one or more modular shading panels in a floating or a fixed position on or above a surface of the body of water.

5. The method of claim 4 wherein the body of water is a river, canal, reservoir, fish farm tank or pond, or hatchery.

6. The method of claim 4 wherein the one or more modular shading panels are placed in step (b) to float on the surface of the body of water.

7. The method of claim 4 wherein the closed-loop frame is a single piece frame.

8. The method of claim 7 wherein the closed-loop frame is an extruded frame.

9. The method of claim 4 wherein the closed-loop frame includes at least one cross-bracing member extending across the closed-loop frame from one side of the closed-loop frame to an opposite side of the closed loop frame.

10. The method of claim 4 wherein the closed-loop frame comprises a plurality of frame segments which are connected together to form a continuous loop.

11. A method of protecting and reducing energy losses from rooftops and rooftop equipment comprising the steps of:
a) forming one or more modular panels, each of which comprises a closed-loop frame and a covering wherein
1) the covering comprises a first layer, a second layer, a closed peripheral portion where the first layer and the second layer are joined, and an open peripheral portion and
2) the closed-loop frame is fully received in the covering through the open peripheral portion and the open peripheral portion is closed to form the modular panel wherein the closed-loop frame is fully contained in and concealed by the covering, the first layer of the covering forms a first side of the modular panel, the second layer of the covering forms an opposing second side of the modular panel, and the first side of the modular panel is spaced apart from the second side of the modular panel and
b) positioning the one or more modular panels on a rooftop of a residential, commercial, or other building.

12. The method of claim 11 wherein in step (b), a plurality of the modular panels are positioned substantially end-to-end over a rooftop electrical line, conduit, or raceway.

13. The method of claim 11 wherein in step (b), the one or more modular panels are positioned over a skylight.

14. The method of claim 11 wherein in step (b), a plurality of the modular panels are positioned adjacent to and over a rooftop air conditioning unit.

15. The method of claim 11 wherein in step (b), the one or more modular panels are positioned at an angle of at least 30° from horizontal over a guttering or other rainwater collection or routing structure to direct falling rainwater into the guttering or other rainwater collection or routing structure.

16. The method of claim 15 wherein the one or more modular panels are positioned at an angle of at least 45° from horizontal.

17. The method of claim 11 wherein the closed-loop frame is an extruded frame.

18. The method of claim 11 wherein the closed-loop frame includes at least one cross-bracing member extending across the closed-loop frame from one side of the closed-loop frame to an opposite side of the closed loop frame.

19. The modular panel of claim 11 wherein the closed-loop frame has a substantially rectangular shape with rounded or squared corners.

20. The method of claim 11 wherein the closed-loop frame comprises a plurality of frame segments which are connected together to form a continuous loop.
